(19) United States
(12) Patent Application Publication
(10) Pub. No.: US 2025/0146215 A1
(43) Pub. Date: May 8, 2025

(54) Stretched Microporous Laminates

(71) Applicant: DDP SPECIALTY ELECTRONIC MATERIALS US, LLC, WILMINGTON, DE (US)

(72) Inventor: WENYI HUANG, MIDLAND, MI (US)

(21) Appl. No.: 18/932,491

(22) Filed: Oct. 30, 2024

Related U.S. Application Data
(60) Provisional application No. 63/595,896, filed on Nov. 3, 2023.

(51) Int. Cl. D06N 3/04; D06N 3/00

(52) U.S. Cl. CPC D06N 3/045; D06N 3/0011; D06N 3/0036; D06N 3/0038; D06N 3/007; D06N 3/0088; D06N 2205/06; D06N 2209/10; D06N 2209/123; D06N 2209/128; D06N 2211/06

(57) ABSTRACT

A microporous laminate comprising a microporous polymeric surface coating comprising polypropylene copolymer on a nonwoven substrate, the microporous polymeric surface coating having a matrix phase of polypropylene homopolymer chain segments and a plurality of domains of ethylene-containing copolymer chain segments within said matrix phase, the domains of the ethylene-containing copolymer chain segments further comprising an inclusion phase of said polypropylene homopolymer chain segments, wherein the domains of said ethylene-containing copolymer chain segments are fractured to form micropores in the microporous polymeric surface coating, wherein (a) the microporous polymeric surface coating has an average thickness of 0.4 to 3.9 mils (10 to 100 micrometers) and the microporous laminate has a trapezoid tear of 40 to 225 Newtons (9 to 50 lbs-force); or (b) the microporous polymeric surface coating has an average thickness of 0.5 to 3.0 mils (12.7 to 76.2 micrometers) and the microporous laminate has a Gurley air permeability of 20 to 150 seconds/100 cm³ of air.

### BACKGROUND OF THE INVENTION

### Field of the Invention

This invention relates to tough, strong, and liquid water-resistant microporous laminates that are additionally water vapor permeable. Such microporous laminates are suitable for use in various applications in the building construction industry, particularly in sheathing and roofing applications. Additionally, the microporous laminates can also find application in healthcare and packaging applications.

### Description of Related Art

United States Pat. Appl. Publication US 2021/0095110 to Huang et al. and United States Pat. Appl. Publication US 2022/0298340 to Huang et al disclose microporous polymer film, wherein the film porosity is achieved through the use of a specific types of PP copolymer-containing polymers to first make a nonporous film having microphase segregation of major and minor polymer domains, followed by a sequential cold/hot stretching process that induces micropore formation by breakage of the minor domains and forming the microporous film. Also disclosed are subsequently combining the fully formed microporous film with a nonwoven substrate to form a laminate.

The microporous films of Huang et al., or traditional polyolefin microporous films based on the use of the additive calcium carbonate (CaCO₃) for increased porosity, by themselves usually have relatively low breaking strength and trapezoid tear resistance (for example, less than 3 lbs for 5 mil films) due to the presence of the microporous structure in the film. This poses challenges in using the films in roofing & building construction applications, especially for water-resistive barrier (WRB) applications where installers need to peel the film from the laminated boards during the installation.

The incumbent technologies laminate these fully formed microporous films with a nonwoven, mesh, or other reinforcing substrate by adhesive lamination, thermal calendar point bonding, or ultrasonic bonding. Adhesives are non-breathable, so if adhesive lamination is used, the breathability of the microporous film can be reduced by ingression of the adhesive, and the presence of the adhesive can also diminish the heat aging performance of the laminate. If thermal calendar point bonding or ultrasonic bonding is used, even if a substantial nonwoven substrate is used, the microporous film remains easy to break from or on the substrate, and therefore has durability issues for roofing and building construction applications, such as the WRB application.

Therefore, for roofing and building construction applications, what is needed is enhanced trapezoid tear resistance and breaking strength for these products that combine a microporous film and a nonwoven substrate; such products can also have additional improved or surprising properties related to water vapor permeability, liquid water holdout or hydrohead, and Gurley air permeability. Such products are not limited to roofing and building construction applications but can also find use in medical and other applications.

### BRIEF SUMMARY OF THE INVENTION

This invention relates to a microporous laminate comprising a first microporous polymeric surface coating on a nonwoven substrate, the nonwoven substrate having a first surface and an opposing second surface; the first microporous polymeric surface coating comprising polypropylene copolymer, said polypropylene copolymer comprising polypropylene homopolymer chain segments and ethylene-containing copolymer chain segments in an amount of:
i) 50 to 95 weight percent polypropylene homopolymer chain segments, based on the weight of the polypropylene copolymer; or 43 to 79 mole percent polypropylene homopolymer chain segments, based on the mole content of polymerized units of polypropylene in the polypropylene homopolymer chain segments as a percentage of the total mole content of polymerized monomer units in the polypropylene copolymer; and
ii) 5 to 50 weight percent of ethylene-containing copolymer chain segments based on the weight of the polypropylene copolymer; or 21 to 57 mole percent of ethylene-containing copolymer chain segments based on the mole content of polymerized monomer units in the ethylene-containing copolymer chain segments as a percentage of the total mole content of polymerized monomer units in the polypropylene copolymer;
wherein at least a portion of the ethylene-containing copolymer chain segments comprise polymerized units of ethylene in an amount of at least 45 weight percent, based on the weight of the ethylene-containing copolymer chain segments; or at least 55 mole percent, based on the mole content of polymerized units of ethylene in the ethylene-containing copolymer chain segments as a percentage of the total mole content of polymerized monomer units in the ethylene-containing copolymer chain segments;
wherein the first microporous polymeric surface coating has a matrix phase of said polypropylene homopolymer chain segments, the matrix phase further having a plurality of domains of said ethylene-containing copolymer chain segments within said matrix phase, the domains of the ethylene-containing copolymer chain segments further comprising an inclusion phase, within said domains, of said polypropylene homopolymer chain segments,
wherein the domains of said ethylene-containing copolymer chain segments within the matrix phase are fractured to form micropores in the first microporous polymeric surface coating, the first microporous polymeric surface coating having said fractured domains of ethylene-containing copolymer chain segments having an average thickness of 0.4 to 3.9 mils (10 to 100 micrometers), and
wherein the nonwoven substrate comprises a spunbonded nonwoven having a random network of continuous filaments of thermoplastic polymer bonded together at crossover points in the random network;
wherein the polypropylene copolymer of the first microporous polymeric surface coating is fused to continuous filaments on the first surface of the nonwoven substrate; and
wherein the microporous laminate has a trapezoid tear of 40 to 225 Newtons (9 to 50 lbs-force).

This invention also relates to a process for forming a microporous laminate, the microporous laminated comprising a first microporous polymeric surface coating on a nonwoven substrate, the nonwoven substrate having a first surface and an opposing second surface, the process comprising the steps of:
A) surface coating a molten layer of polymer on the first surface of the nonwoven substrate, followed by cooling, to form a non-porous laminate having a non-porous layer of said polymer on said first surface, the non-porous layer of polymer having an areal loading of 22.9 to 114.3 gsm and a thickness of 1-5 mils (25 to 125 micrometers), wherein:
   a) the polymer is a composition comprising polypropylene copolymer, said polypropylene copolymer comprising polypropylene homopolymer chain segments and ethylene-containing copolymer chain segments in an amount of:
      i) 50 to 95 weight percent polypropylene homopolymer chain segments, based on the weight of the polypropylene copolymer; or 43 to 79 mole percent polypropylene homopolymer chain segments, based on the mole content of polymerized units of polypropylene in the polypropylene homopolymer chain segments as a percentage of the total mole content of polymerized monomer units in the polypropylene copolymer; and
      ii) 5 to 50 weight percent of ethylene-containing copolymer chain segments based on the weight of the polypropylene copolymer; or 21 to 57 mole percent of ethylene-containing copolymer chain segments based on the mole content of polymerized monomer units in the ethylene-containing copolymer chain segments as a percentage of the total mole content of polymerized monomer units in the polypropylene copolymer;
      wherein at least a portion of the ethylene-containing copolymer chain segments comprise polymerized units of ethylene in an amount of at least 45 weight percent, based on the weight of the ethylene-containing copolymer chain segments; or at least 55 mole percent, based on the mole content of polymerized units of ethylene in the ethylene-containing copolymer chain segments as a percentage of the total mole content of polymerized monomer units in the ethylene-containing copolymer chain segments, and
      wherein the non-porous layer of polymer has a matrix phase of said polypropylene homopolymer chain segments, the matrix phase further having a plurality of domains of said ethylene-containing copolymer chain segments within said matrix phase, the domains of the ethylene-containing copolymer chain segments further comprising an inclusion phase, within said domains, of said polypropylene homopolymer chain segments, and
   b) the nonwoven substrate comprising a spunbonded nonwoven having a random network of continuous filaments of thermoplastic polymer bonded together at crossover points in the random network; the nonwoven substrate having a basis weight of 30 to 100 gsm, and an elongation at break at room temperature of less than 50 percent;
B) subjecting the non-porous laminate to sequential cold and hot stretching steps comprising:
   (i) at least one cold stretching step of 20 to 50 percent at a temperature of less than 30° C.; and
   (ii) at least one hot stretching step of 20 to 50 percent at a temperature greater than 100° C.;
   to fracture the domains of said ethylene-containing copolymer chain segments within the matrix phase to form micropores in the non-porous layer of polymer and produce a microporous laminate.

This invention further relates to a process for forming a microporous laminate, the microporous laminated comprising a first microporous polymeric surface coating on a first surface of a nonwoven substrate, and a second microporous polymeric surface coating on an opposing second surface of a nonwoven substrate, the process comprising the steps of:
A) surface coating a first molten layer of polymer on the first surface of the nonwoven substrate, followed by cooling, and surface coating a second molten layer of polymer on the opposing second surface of the nonwoven substrate, also followed by cooling, to form a non-porous laminate having a first non-porous layer of said polymer on said first surface and a second non-porous layer of said polymer on said second opposing surface,
   each non-porous layer of polymer having an areal loading of 22.9 to 114.3 gsm and a thickness of 1-5 mils (25 to 125 micrometers), wherein:
   a) the polymer is a composition comprising polypropylene copolymer, said polypropylene copolymer comprising polypropylene homopolymer chain segments and ethylene-containing copolymer chain segments in an amount of:
      i) 50 to 95 weight percent polypropylene homopolymer chain segments, based on the weight of the polypropylene copolymer; or 43 to 79 mole percent polypropylene homopolymer chain segments, based on the mole content of polymerized units of polypropylene in the polypropylene homopolymer chain segments as a percentage of the total mole content of polymerized monomer units in the polypropylene copolymer; and
      ii) 5 to 50 weight percent of ethylene-containing copolymer chain segments based on the weight of the polypropylene copolymer; or 21 to 57 mole percent of ethylene-containing copolymer chain segments based on the mole content of polymerized monomer units in the ethylene-containing copolymer chain segments as a percentage of the total mole content of polymerized monomer units in the polypropylene copolymer;
      wherein at least a portion of the ethylene-containing copolymer chain segments comprise polymerized units of ethylene in an amount of at least 45 weight percent, based on the weight of the ethylene-containing copolymer chain segments; or at least 55 mole percent, based on the mole content of polymerized units of ethylene in the ethylene-containing copolymer chain segments as a percentage of the total mole content of polymerized monomer units in the ethylene-containing copolymer chain segments, and
      wherein each non-porous layer of polymer has a matrix phase of said polypropylene homopolymer chain segments, the matrix phase further having a plurality of domains of said ethylene-containing copolymer chain segments within said matrix phase, the domains of the ethylene-containing copolymer chain segments further comprising an inclusion phase, within said domains, of said polypropylene homopolymer chain segments, and
   b) the nonwoven substrate comprising a spunbonded nonwoven having a random network of continuous filaments of thermoplastic polymer bonded together at crossover points in the random network; the nonwoven substrate having a basis weight of 30 to 100 gsm, and an elongation at break at room temperature of less than 50 percent;
B) subjecting the non-porous laminate to sequential cold and hot stretching steps comprising:
   (i) at least one cold stretching step of 20 to 50 percent at a temperature of less than 30° C.; and
   (ii) at least one hot stretching step of 20 to 50 percent at a temperature greater than 100° C.;
   to fracture the domains of said ethylene-containing copolymer chain segments within the matrix phase to form micropores in each non-porous layer of polymer and produce a microporous laminate.

This invention further relates to a microporous laminate comprising a first microporous polymeric surface coating on a nonwoven substrate, the nonwoven substrate having a first surface and an opposing second surface; the first microporous polymeric surface coating comprising polypropylene copolymer, said polypropylene copolymer comprising polypropylene homopolymer chain segments and ethylene-containing copolymer chain segments in an amount of:
i) 50 to 95 weight percent polypropylene homopolymer chain segments, based on the weight of the polypropylene copolymer; or 43 to 79 mole percent polypropylene homopolymer chain segments, based on the mole content of polymerized units of polypropylene in the polypropylene homopolymer chain segments as a percentage of the total mole content of polymerized monomer units in the polypropylene copolymer; and
ii) 5 to 50 weight percent of ethylene-containing copolymer chain segments based on the weight of the polypropylene copolymer; or 21 to 57 mole percent of ethylene-containing copolymer chain segments based on the mole content of polymerized monomer units in the ethylene-containing copolymer chain segments as a percentage of the total mole content of polymerized monomer units in the polypropylene copolymer;
wherein at least a portion of the ethylene-containing copolymer chain segments comprise polymerized units of ethylene in an amount of at least 45 weight percent, based on the weight of the ethylene-containing copolymer chain segments; or at least 55 mole percent, based on the mole content of polymerized units of ethylene in the ethylene-containing copolymer chain segments as a percentage of the total mole content of polymerized monomer units in the ethylene-containing copolymer chain segments;
wherein the first microporous polymeric surface coating has a matrix phase of said polypropylene homopolymer chain segments, the matrix phase further having a plurality of domains of said ethylene-containing copolymer chain segments within said matrix phase, the domains of the ethylene-containing copolymer chain segments further comprising an inclusion phase, within said domains, of said polypropylene homopolymer chain segments,
wherein the domains of said ethylene-containing copolymer chain segments within the matrix phase are fractured to form micropores in the first microporous polymeric surface coating, the first microporous polymeric surface coating having said fractured domains of ethylene-containing copolymer chain segments having an average thickness of 0.5 to 3.0 mils (12.7 to 76.2 micrometers), and
wherein the nonwoven substrate is a spunbonded nonwoven, a meltblown nonwoven, or some combination of spunbonded and meltblown nonwoven layers; the nonwoven substrate comprising a random network of filaments or fibers of thermoplastic polymer bonded together;
wherein the polypropylene copolymer of the first microporous polymeric surface coating is fused to filaments or fibers on the first surface of the nonwoven substrate; and
wherein the microporous laminate has a Gurley air permeability of 20 to 150 seconds/100 cm³ of air.

This invention also relates to a process for forming a microporous laminate, the microporous laminated comprising a first microporous polymeric surface coating on a first surface of a nonwoven substrate, the process comprising the steps of:
A) surface coating a molten layer of polymer on the first surface of the nonwoven substrate, followed by cooling, to form a non-porous laminate having a non-porous layer of said polymer on said first surface,
   the non-porous layer of polymer having an areal loading of 22.9 to 114.3 gsm and a thickness of 1-5 mils (25 to 125 micrometers), wherein:
   a) the polymer is a composition comprising polypropylene copolymer, said polypropylene copolymer comprising polypropylene homopolymer chain segments and ethylene-containing copolymer chain segments in an amount of:
      i) 50 to 95 weight percent polypropylene homopolymer chain segments, based on the weight of the polypropylene copolymer; or 43 to 79 mole percent polypropylene homopolymer chain segments, based on the mole content of polymerized units of polypropylene in the polypropylene homopolymer chain segments as a percentage of the total mole content of polymerized monomer units in the polypropylene copolymer; and
      ii) 5 to 50 weight percent of ethylene-containing copolymer chain segments based on the weight of the polypropylene copolymer; or 21 to 57 mole percent of ethylene-containing copolymer chain segments based on the mole content of polymerized monomer units in the ethylene-containing copolymer chain segments as a percentage of the total mole content of polymerized monomer units in the polypropylene copolymer;
      wherein at least a portion of the ethylene-containing copolymer chain segments comprise polymerized units of ethylene in an amount of at least 45 weight percent, based on the weight of the ethylene-containing copolymer chain segments; or at least 55 mole percent, based on the mole content of polymerized units of ethylene in the ethylene-containing copolymer chain segments as a percentage of the total mole content of polymerized monomer units in the ethylene-containing copolymer chain segments, and
      wherein the non-porous layer of polymer has a matrix phase of said polypropylene homopolymer chain segments, the matrix phase further having a plurality of domains of said ethylene-containing copolymer chain segments within said matrix phase, the domains of the ethylene-containing copolymer chain segments further comprising an inclusion phase, within said domains, of said polypropylene homopolymer chain segments, and
   b) the nonwoven substrate comprising a random network of filaments or fibers of thermoplastic polymer bonded together in the form of a spunbonded nonwoven, a meltblown nonwoven, or some combination of spunbonded and meltblown nonwoven layers; the nonwoven substrate having a basis weight of 30 to 100 gsm, and an elongation at break at room temperature of 50 percent or greater;
B) subjecting the non-porous laminate to sequential cold and hot stretching steps comprising:
   (i) at least one cold stretching step of 50 to 85 percent at a temperature of less than 30° C.; and
   (ii) at least one hot stretching step of 100 to 150 percent at a temperature greater than 100° C.;
   to fracture the domains of said ethylene-containing copolymer chain segments within the matrix phase to form micropores in the non-porous layer of polymer and produce the microporous laminate.

This invention further relates to a process for forming a microporous laminate, the microporous laminated comprising a first microporous polymeric surface coating on a first surface of a nonwoven substrate, and a second microporous polymeric surface coating on an opposing second surface of a nonwoven substrate, the process comprising the steps of:
A) surface coating a first molten layer of polymer on the first surface of the nonwoven substrate, followed by cooling, and surface coating a second molten layer of polymer on the opposing second surface of the nonwoven substrate, also followed by cooling, to form a non-porous laminate having a first non-porous layer of said polymer on said first surface and a second non-porous layer of said polymer on said second opposing surface, each non-porous layer of polymer having an areal loading of 22.9 to 114.3 gsm and a thickness of 1-5 mils (25 to 125 micrometers), wherein:
   a) the polymer is a composition comprising polypropylene copolymer, said polypropylene copolymer comprising polypropylene homopolymer chain segments and ethylene-containing copolymer chain segments in an amount of:
      i) 50 to 95 weight percent polypropylene homopolymer chain segments, based on the weight of the polypropylene copolymer; or 43 to 79 mole percent polypropylene homopolymer chain segments, based on the mole content of polymerized units of polypropylene in the polypropylene homopolymer chain segments as a percentage of the total mole content of polymerized monomer units in the polypropylene copolymer; and
      ii) 5 to 50 weight percent of ethylene-containing copolymer chain segments based on the weight of the polypropylene copolymer; or 21 to 57 mole percent of ethylene-containing copolymer chain segments based on the mole content of polymerized monomer units in the ethylene-containing copolymer chain segments as a percentage of the total mole content of polymerized monomer units in the polypropylene copolymer;
      wherein at least a portion of the ethylene-containing copolymer chain segments comprise polymerized units of ethylene in an amount of at least 45 weight percent, based on the weight of the ethylene-containing copolymer chain segments; or at least 55 mole percent, based on the mole content of polymerized units of ethylene in the ethylene-containing copolymer chain segments as a percentage of the total mole content of polymerized monomer units in the ethylene-containing copolymer chain segments, and
      wherein each non-porous layer of polymer has a matrix phase of said polypropylene homopolymer chain segments, the matrix phase further having a plurality of domains of said ethylene-containing copolymer chain segments within said matrix phase, the domains of the ethylene-containing copolymer chain segments further comprising an inclusion phase, within said domains, of said polypropylene homopolymer chain segments, and
   b) the nonwoven substrate comprising a spunbonded nonwoven having a random network of filaments or fibers of thermoplastic polymer bonded together at crossover points in the random network; the nonwoven substrate having a basis weight of 30 to 100 gsm, and an elongation at break at room temperature of 50 percent or greater;
B) subjecting the non-porous laminate to sequential cold and hot stretching steps comprising:
   (i) at least one cold stretching step of 50 to 85 percent at a temperature of less than 30° C.; and
   (ii) at least one hot stretching step of 100 to 150 percent at a temperature greater than 100° C.;
   to fracture the domains of said ethylene-containing copolymer chain segments within the matrix phase to form micropores in the non-porous layer of polymer and produce a microporous laminate.

### BRIEF DESCRIPTION OF THE DRAWINGS

FIG. 1 is a representative TEM image of the unstretched non-porous polymeric surface coating prior to stretching, shown with a 1 micron scale bar.

FIG. 2 is an optical microscope image of a representative cross section of the unstretched non-porous monolithic sheet containing opposing layers of the non-porous polymeric surface coating on the polypropylene substrate prior to stretching to create the microporous laminate.

FIG. 3 is a representation of one possible continuous process for making a microporous laminate on an apparatus comprising an extrusion laminating device 50, followed by a cold-stretching device 51, followed by a hot-stretching device 52, followed by a cooling device 53, and finally a winding device 54.

### DETAILED DESCRIPTION OF THE INVENTION

The present inventions relate to microporous laminates comprising a microporous polymeric surface coating comprising polypropylene copolymer on a nonwoven substrate, wherein the microporous polymeric surface coating has a matrix phase of polypropylene homopolymer chain segments and a plurality of domains of ethylene-containing copolymer chain segments within said matrix phase, the domains of the ethylene-containing copolymer chain segments further comprising an inclusion phase of said polypropylene homopolymer chain segments, wherein the domains of said ethylene-containing copolymer chain segments are fractured to form micropores in the microporous polymeric surface coating.

Additionally, the polypropylene copolymer of the microporous polymeric surface coating is locally fused to filaments or fibers on the first surface of the nonwoven substrate to prevent peeling of the microporous polymeric surface from the nonwoven substrate. This is achieved by applying a surface coating of the molten polypropylene copolymer onto the nonwoven substrate to first form a non-porous monolithic sheet having excellent bonding between the surface coating and nonwoven substrate, followed by stretching the monolithic sheet in two steps to fracture the domains of said ethylene-containing copolymer chain segments (while also stretching the nonwoven substrate). The first stretching step stretches the laminate at less than 30° C., preferably 15° C. to 28° C., while the second stretching step stretches the laminate at a temperature of greater than 100° C.

In one embodiment, the microporous laminate is made by forming the non-porous monolithic sheet using a nonwoven substrate having an elongation at break (measured at room temperature) of less than 50 percent and stretching that monolithic sheet 20 to 50 percent in both the first and second stretching steps. This preferably forms a microporous laminate having a microporous polymeric surface coating having an average thickness of 0.4 to 3.9 mils (10 to 100 micrometers), and the microporous laminate has a trapezoid tear of 40 to 225 Newtons (9 to 50 lbs-force). This embodiment is referred to herein as the “low-elongation substrate embodiment” of the microporous laminate, and such microporous laminates can be suitable and desirable for roofing and other construction applications.

In another embodiment, the microporous laminate is made by forming the non-porous monolithic sheet using a nonwoven substrate having an elongation at break of 50 percent or greater (measured at room temperature) and stretching that monolithic sheet 50 to 85 percent in the first stretching step and further stretching that sheet 100 to 150 percent in the second stretching step. This preferably forms a microporous laminate having a microporous polymeric surface coating having an average thickness of 0.5 to 3.0 mils (12.7 to 76.2 micrometers), and the microporous laminate has a Gurley air permeability of 20 to 150 seconds/100 cm³ of air. This embodiment is referred to herein as the “high-elongation substrate embodiment” of the microporous laminate, and such microporous laminates can be suitable and desirable for medical applications.

It is believed the polypropylene copolymer composition and process for making and stretching the non-porous monolithic sheet to a microporous laminate in two stretching steps, as described herein, forms a unique pore structure in the microporous laminate; providing, for example, uniform smaller micropores in the coating layer that have a generally non-interconnecting nature, resulting in breathable membranes that exhibit exceptional barrier to liquid water and air while achieving a desirable water vapor permeance. The micropores have an average pore diameter of about 100 nm to 1 micrometer, and in some embodiments preferably having an average pore diameter of 40 to 75 nm, as measured by mercury intrusion. In addition, these breathable polymeric sheet materials are based on a polypropylene, meaning they are naturally hydrophobic and thermally stable, as polypropylene has a melting temperature of about 165° C.

Specifically, for the embodiment of the microporous laminate is made using a nonwoven substrate having an elongation at break (measured at room temperature) of less than 50 percent (the low-elongation substrate embodiment) and preferably having a trapezoid tear of 40 to 225 Newtons (9 to 50 lbs-force), the microporous laminate comprises a first microporous polymeric surface coating on a nonwoven substrate, the nonwoven substrate having a first surface and an opposing second surface; the first microporous polymeric surface coating comprising polypropylene copolymer, said polypropylene copolymer comprising polypropylene homopolymer chain segments and ethylene-containing copolymer chain segments in an amount of:
i) 50 to 95 weight percent polypropylene homopolymer chain segments, based on the weight of the polypropylene copolymer; or 43 to 79 mole percent polypropylene homopolymer chain segments, based on the mole content of polymerized units of polypropylene in the polypropylene homopolymer chain segments as a percentage of the total mole content of polymerized monomer units in the polypropylene copolymer; and
ii) 5 to 50 weight percent of ethylene-containing copolymer chain segments based on the weight of the polypropylene copolymer; or 21 to 57 mole percent of ethylene-containing copolymer chain segments based on the mole content of polymerized monomer units in the ethylene-containing copolymer chain segments as a percentage of the total mole content of polymerized monomer units in the polypropylene copolymer.
   At least a portion of the ethylene-containing copolymer chain segments comprise polymerized units of ethylene in an amount of at least 45 weight percent, based on the weight of the ethylene-containing copolymer chain segments; or at least 55 mole percent, based on the mole content of polymerized units of ethylene in the ethylene-containing copolymer chain segments as a percentage of the total mole content of polymerized monomer units in the ethylene-containing copolymer chain segments. Additionally, the first microporous polymeric surface coating has a matrix phase of said polypropylene homopolymer chain segments, the matrix phase further having a plurality of domains of said ethylene-containing copolymer chain segments within said matrix phase. The domains of the ethylene-containing copolymer chain segments further comprising an inclusion phase, within said domains, of said polypropylene homopolymer chain segments; the domains of said ethylene-containing copolymer chain segments within the matrix phase are fractured to form micropores in the first microporous polymeric surface coating. This first microporous polymeric surface coating having the fractured domains of ethylene-containing copolymer chain segments has an average thickness of 0.4 to 3.9 mils (10 to 100 micrometer).

The nonwoven substrate comprises a spunbonded nonwoven having a random network of continuous filaments of thermoplastic polymer bonded together at crossover points in the random network, with the polypropylene copolymer of the first microporous polymeric surface coating fused to continuous filaments on the first surface of the nonwoven substrate.

The low-elongation substrate embodiment of the microporous laminate has a trapezoid tear of 40 to 225 Newtons (9 to 50 lbs-force), preferably 15 to 30 lbs-force.

The microporous laminate can have other desirable properties. Specifically, the microporous laminate can have a basis weight of 30 to 120 g/m², preferably 45 g/m² to 100 g/m². The microporous laminate can also have a thickness of 3 to 15 mils (0.076 to 0.381 mm), preferably 6 to 12 mils. The microporous laminate can further have a hydrostatic head of 2 meters or greater, preferably 2.5 meters or greater, preferably 3 meters or greater. The microporous laminate can also have a water vapor permeance of 18 g/(24 hr·m²) or greater, preferably 70 g/(24 hr·m²) or greater. The microporous laminate can further have a tensile strength of 10 lbs/inch (87.6 N/50 mm) or greater, preferably 20 lbs/inch or greater.

In some embodiments, the microporous laminate has only a first microporous polymeric surface coating on one surface of the low-elongation nonwoven substrate. In other embodiments the microporous laminate has a first microporous polymeric surface coating on a first surface of the nonwoven substrate and a second microporous polymeric surface coating on an opposing second surface of the low-elongation nonwoven substrate, forming a sandwich structure with the two microporous polymeric surface coatings forming the outside surfaces of the laminate. That is, in the sandwich structure, in some preferred embodiments, the nonwoven substrate forms the center layer of the microporous laminate.

Preferably the second microporous polymeric surface coating is the same as the first microporous polymeric surface coating; that is, both surface coatings have essentially the same composition, thickness, and pore structure, or any differences in these parameters are minor and both surface coatings function the same in the desired application, and both are attached their respective surfaces of the nonwoven in the same way.

Specifically, the low-elongation substrate embodiment of the microporous laminate can further comprise a second microporous polymeric surface coating, said second microporous polymeric surface coating being the same as the first microporous polymeric surface coating, and wherein the polypropylene copolymer of the second microporous polymeric surface coating is fused to continuous filaments on the opposing second surface of the nonwoven substrate.

The low-elongation substrate embodiment of the microporous laminate comprising the first microporous polymeric surface coating and second microporous polymeric surface coating on opposing sides of the nonwoven substrate, designated a “two-layer microporous laminate” herein, has a trapezoid tear of 40 to 225 Newtons (9 to 50 lbs-force), preferably 15 to 30 lbs-force, similar to the microporous laminate having only the first microporous polymeric surface coating. The two-layer microporous laminate can have other desirable properties, however. Specifically, the two-layer microporous laminate can have a basis weight of 40 to 150 g/m², preferably 60 to 125 g/m². The two-layer microporous laminate can also have a thickness of 4 to 19 mils (0.10 to 0.48 mm), preferably 8 to 15 mils. The two-layer microporous laminate can further have a hydrostatic head of 3 meters or greater, preferably 3.5 meters or greater. The two-layer microporous laminate can also have a water vapor permeance of 25 g/(24 hr·m²) or greater, preferably 95 g/(24 hr·m²) or greater. The two-layer microporous laminate can further have a tensile strength of 10 lbs/inch (87.6 N/50 mm) or greater, preferably 20 lbs/inch or greater.

All the embodiments herein of the microporous polymeric surface coating comprise polypropylene copolymer, said polypropylene copolymer comprising polypropylene homopolymer chain segments and ethylene-containing copolymer chain segments, as previous stated herein.

As used herein, the term “polypropylene copolymer” means a copolymer comprising a polymer backbone, side chain, or chain segment of polypropylene, specifically such backbone, side chain, or chain segment comprises 15 or more consecutive polymerized units of propylene. A preferred polypropylene copolymer comprises polypropylene homopolymer chain segments (e.g., isotactic polypropylene) and ethylene-containing copolymer chain segments. In some embodiments, the ethylene-containing copolymer chain segments are ethylene-propylene copolymer chain segments. The microporous polymeric surface coating can comprise one or more polypropylene copolymer.

The polypropylene copolymer in the microporous polymeric surface coating comprises polypropylene homopolymer chain segments in an amount of at least about 50% by weight, up to an amount of about 95% by weight, based on the total weight of the microporous polymeric surface coating. In some embodiments, the amount of polypropylene homopolymer chain segments in the microporous polymeric surface coating can be about 50% by weight to about 82% by weight, or from about 60% by weight to about 82% by weight, based on the total weight of the microporous polymeric surface coating.

If viewed from the perspective of mole %, the polypropylene copolymer in the microporous polymeric surface coating comprises polypropylene homopolymer chain segments in an amount of 43 to 79 mole %, based on the mole content of polymerized units of propylene in the polypropylene homopolymer chain segments as a percentage of the total mole content of polymerized monomer units in the microporous polymeric surface coating. In some embodiments, the amount of polypropylene homopolymer chain segments in the microporous polymeric surface coating can be about 43 mole % to about 79 mole %, or from about 50 mole % to about 80 mole %, based on the mole content of polymerized units of propylene in the polypropylene homopolymer chain segments as a percentage of the total mole content of polymerized monomer units in the microporous polymeric surface coating.

The polypropylene homopolymer chain segments present in the microporous polymeric surface coating may derive solely from the polypropylene copolymer component or may be a combination of polypropylene homopolymer chain segments derived from the polypropylene copolymer component and one or more other polymer component comprising polypropylene homopolymer chain segments. Preferably, the polypropylene homopolymer chain segments present in the microporous polymeric surface derive solely from the polypropylene copolymer component.

The polypropylene copolymer in the microporous polymeric surface coating comprises ethylene-containing copolymer chain segments in an amount of at least about 5% to 50% by weight, based on the total weight of the microporous polymeric surface coating. In some embodiments, the microporous polymeric surface coating comprises ethylene-containing copolymer chain segments in an amount of, about 18% by weight to about 50% by weight, or from about 25% by weight to about 40%, by weight based on the total weight of the microporous polymeric surface coating.

If viewed from the perspective of mole %, the microporous polymeric surface coating comprises ethylene-containing copolymer chain segments in an amount of 21 to 57 mole %, based on the mole content of polymerized monomer units in the ethylene-containing copolymer chain segments as a percentage of the total mole content of polymerized monomer units in the polypropylene copolymer of the microporous polymeric surface coating.

In some embodiments, the amount of ethylene-containing copolymer chain segments in the microporous polymeric surface coating is about 21 mole % to about 57 mole %, or from about 20 mole % to about 45 mole %, based on the mole content of polymerized monomer units in the ethylene-containing copolymer chain segments as a percentage of the total mole content of polymerized monomer units in the polypropylene copolymer of the microporous polymeric surface coating.

The ethylene-containing copolymer chain segments present in the microporous polymeric surface coating may derive solely from the polypropylene copolymer component or may be a combination of ethylene-containing copolymer chain segments derived from the polypropylene copolymer component and one or more other polymer component comprising ethylene-containing copolymer chain segments. Preferably, the ethylene-containing copolymer chain segments present in the microporous polymeric surface coating derive solely from the polypropylene copolymer component. Preferably, the ethylene-containing copolymer chain segments are ethylene-propylene copolymer chain segments.

The ethylene-containing copolymer chain segments in the microporous polymeric surface coating comprise at least 45% by weight of polymerized units of ethylene based on the total weight of the ethylene-containing copolymer chain segments. In some embodiments, the amount of ethylene units in the ethylene-containing copolymer chain segments in the microporous polymeric surface coating can be about 45% by weight to about 80% by weight, or from about 45% by weight to about 60% by weight, based on the total weight of the ethylene-containing copolymer chain segments.

If viewed from the perspective of mole %, the ethylene unit content in the ethylene-containing copolymer chain segments in the microporous polymeric surface coating is at least about 55 mole %, based on the mole content of polymerized units of ethylene in the ethylene-containing copolymer chain segments as a percentage of the total mole content of polymerized monomer units in the ethylene-containing copolymer chain segments. In some embodiments, the ethylene unit content in the ethylene-containing copolymer chain segments in the microporous polymeric surface coating is about 55 mole % to about 80 mole %, or from about 55 mole % to about 69 mole %, based on the mole content of polymerized units of ethylene in the ethylene-containing copolymer chain segments as a percentage of the total mole content of polymerized monomer units in the ethylene-containing copolymer chain segments.

The polypropylene copolymer, when surface coated onto a flexible substrate, provides a non-porous monolithic polymeric sheet having microphase segregation/inclusion morphology, that can form a microporous laminate having microporous polymeric surface coating having non-interconnecting pores, when stretched using sequential cold and hot stretching processes described herein.

The polypropylene copolymer in the microporous polymeric surface coating can further comprise additives such things as extrusion processing aids such as lubricants and the like; antioxidants, UV stabilizers, light stabilizers, thermal stabilizers, pigments or other colorants, antistatic agents, flame retardants, anti-block additives, biocides, and the like. UV stabilizers are preferred additives. Examples of these include 5 various hydroxyphenyl benzotrioles, such as those sold as Tinuvin® 328 or Tinuvin® 329 by BASF; hindered amine stabilizers such as those sold as Tinuvin® 770 or Chimassorb® 2020 by BASF. One or more UV stabilizers may be used in conjunction with one or more antioxidants. In some embodiments the polypropylene copolymer in the microporous polymeric surface coating excludes any pore-forming additive that increases the porosity of the final microporous laminate.

Although the polyolefin may contain filler particles, such fillers are preferably absent or, if present, present in only small quantities such as up to 3%, up to 2%, up to 1%, or up to 0.5% of the combined weight of filler particles and the polyolefin. Such fillers are particulate materials that are thermally stable (i.e., do not melt or thermally degrade) under the conditions of the extrusion lamination process. In some embodiments the polypropylene copolymer in the microporous polymeric surface coating excludes any pore-forming filler that increases the porosity of the final microporous laminate.

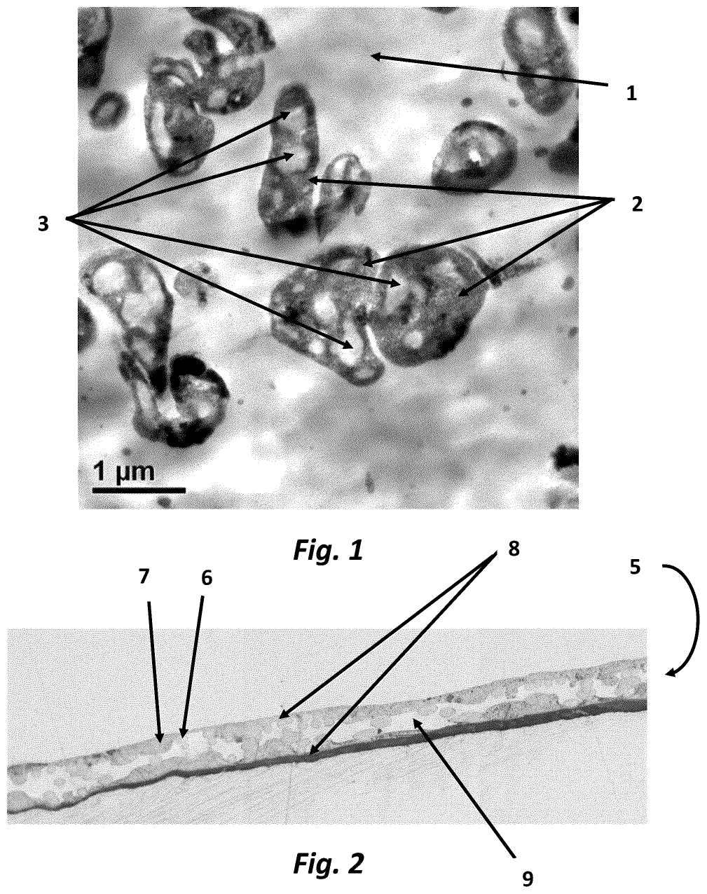

FIG. 1 is a representative TEM image of the unstretched non-porous polymeric surface coating prior to stretching, shown with a 1 micron scale bar. This illustrates the microphase segregation and associated domain/inclusion formation as previously discussed herein. Shown is the lighter-gray matrix phase 1 containing the polypropylene homopolymer chain segments, and the matrix phase further has a plurality of darker-gray domains 2 of ethylene-containing copolymer chain segments. Additionally, the domains of the ethylene-containing copolymer chain segments further comprise a lighter-gray inclusion phase 3 of the polypropylene homopolymer chain segments. (Not all domains/inclusion phases identified with reference numerals.)

It is believed that the inclusion morphology of the polypropylene homopolymer chain segment microphase(s) in the ethylene-containing copolymer chain segment domains, within the polypropylene homopolymer chain segment matrix, enables the transfer of the stretching force to the microphase domains, which preferentially fractures the microphase domains and initiates the unique micropore formation in the copolymer layer when stretched using the sequential cold and hot stretching processes. Further, it is believed that without the polypropylene homopolymer chain segment inclusion morphology in the ethylene-containing copolymer chain segment domains, the ethylene-containing copolymer chain segment domains would simply elongate when stretched, without the desired micropore formation; that is, until holes (macropores having a diameter much greater than 1 micrometer) were uncontrollably torn in the polymer layer.

The microporous polymeric surface coating having the fractured domains of ethylene-containing copolymer chain segments has an average thickness of 0.4 to 3.9 mils (10 to 100 micrometers). In some embodiments, the microporous polymeric surface coating having the fractured domains has an average thickness of 1 to 3 mils.

In some embodiments, the nonwoven substrate of the microporous laminate is a spunbonded nonwoven having a random network of continuous filaments of thermoplastic polymer bonded together at crossover points in the random network. The term “fiber” is used interchangeably with “filament” herein and means a relatively flexible unit of matter having a high ratio of length to width across its cross-sectional area perpendicular to its length. The cross section of the filaments described herein can be any shape but are typically solid circular or round shaped. Fibers and filaments can be discontinuous or continuous. Continuous fibers or filaments are typically the filaments that are continuously extruded from a spinneret that undergo no additional intentional treatment to make them discontinuous. Obviously, discontinuous fibers or filaments have that additional intentional treatment to shorten the fibers or filaments to a desired length, which is typically in the form of cutting or shearing the continuous filament.

The term “nonwoven” as used herein a network of filaments and/or fibers forming a flexible planar sheet material producible without weaving or knitting and held together by either (i) mechanical interlocking of at least some of the fibers or filaments, (ii) fusing at least some parts of some of the fibers or filaments, or (iii) bonding at least some of the fibers or filaments by use of a binder material. Nonwovens as used herein preferably include spunbonded nonwovens, meltblown nonwovens, and combinations thereof.

Spunbonded nonwovens are typically formed by extruding molten thermoplastic polymer material as continuous filaments from a plurality of fine capillaries of a spinneret, that are then drawn and randomly deposited onto a screen; the filaments then being bonded together. Spunbonded nonwoven is sometimes used as a generic term to include any fiber sheet that contains fibrous material in sheet form that is in turn heat treated to melt some constituent of the sheet and bond the fibrous material together. Meltblown nonwovens are typically formed by extruding a molten thermoplastic polymer through a plurality of fine, usually circular, capillaries as molten filaments into a high velocity gas (e.g. air) stream. The high velocity gas stream attenuates the filaments of molten thermoplastic polymer material to reduce their diameter to between about 0.5 and 10 microns. Meltblown fibers are generally discontinuous fibers. Meltblown fibers carried by the high velocity gas stream are normally deposited on a collecting surface to form a web of randomly dispersed fibers. One common “spunbonded” nonwoven is a “SMS” nonwoven, which combines a layer of meltblown nonwoven (M) between two layers of spunbonded nonwoven(S), the layers being combined together on a spinning machine designed to make nonwovens having different types of layers. Other “spunbonded” combinations are possible.

In some embodiments, the thermoplastic polymer of the polymeric filaments of the nonwoven substrate comprises polypropylene, polyester, nylon, or a mixture thereof. In some preferred embodiments, the thermoplastic polymer comprises polypropylene.

In the broadest sense, the term “polypropylene” as used herein for the thermoplastic polymer of the polymeric filaments of the nonwoven substrate, is intended to embrace not only homopolymers of propylene but also copolymers wherein at least 85% of the recurring units are propylene units. Likewise, as used herein for the thermoplastic polymer of the polymeric filaments, the term “polyester” as used herein is intended to embrace polymers wherein at least 85% of the recurring units are condensation products of dicarboxylic acids and dihydroxy alcohols with polymer linkages created by formation of an ester unit. This includes aromatic, aliphatic, saturated, and unsaturated di-acids and di-alcohols. This “polyester” as used herein also includes copolymers (such as block, graft, random and alternating copolymers), blends, and modifications thereof. A common example of a polyester is poly(ethylene terephthalate) which is a condensation product of ethylene glycol and terephthalic acid. Additionally, as used herein for the thermoplastic polymer of the polymeric filaments, the term “nylon” is meant to include aliphatic polyamide polymers; and polyhexamethylene adipamide (nylon 66) is the preferred nylon polymer. Other nylons include polycaprolactam (nylon 6), polybutyrolactam (nylon 4), poly(9-aminononanoic acid) (nylon 9), polyenantholactam (nylon 7), polycapryllactam (nylon 8), polyhexamethylene sebacamide (nylon 6, 10), and the like.

In some embodiments the polypropylene copolymer of the first microporous polymeric surface coating is locally fused to continuous filaments located on the first surface of the nonwoven substrate. This allows the nonwoven substrate to be stretched, and transfer that stretching in a controlled manner to the very thin polymeric surface coating without raising the filaments in the nonwoven substrate, which could then poke through the thin coating to the exterior surface of the laminate.

FIG. 2 provides a representative optical microscope image of a cross section of the unstretched non-porous monolithic sheet 5 containing the non-porous polymeric surface coating and polypropylene substrate prior to stretching to create the microporous laminate. The non-porous monolithic sheet 5 has discernable filaments 6 and combinations 7 of polypropylene filaments and polypropylene copolymer polymer from the non-porous polymeric surface coating that are melted together. On each side of the sheet is the thin non-porous polymeric surface coating 8. While one thin non-porous polymeric surface coating is clearly shown on the upper side of the sheet, the thin non-porous polymeric surface coating on the opposing side is obscured by the dark line at the bottom of the sheet (This is an artifact of the microscope.) Additionally, there is void area 9 containing no polymer from the surface coating or filaments from the nonwoven substrate.

The low-elongation embodiment of the microporous laminate can be made using a nonwoven substrate having an elongation at break (measured at room temperature) of less than 50 percent; the resultant microporous laminate preferably has a trapezoid tear of 40 to 225 Newtons (9 to 50 lbs-force). Specifically, one process for forming a microporous laminate, comprising a first microporous polymeric surface coating on a nonwoven substrate, the nonwoven substrate having a first surface and an opposing second surface, comprises the steps of:
A) surface coating a molten layer of polymer on the first surface of the nonwoven substrate, followed by cooling, to form a non-porous laminate having a non-porous layer of said polymer on said first surface,
   the non-porous layer of polymer having an areal loading of 22.9 to 114.3 gsm and a thickness of 1-5 mils (25 to 125 micrometers), wherein:
   a) the polymer is a composition comprising polypropylene copolymer, said polypropylene copolymer comprising polypropylene homopolymer chain segments and ethylene-containing copolymer chain segments in an amount of:
      i) 50 to 95 weight percent polypropylene homopolymer chain segments, based on the weight of the polypropylene copolymer; or 43 to 79 mole percent polypropylene homopolymer chain segments, based on the mole content of polymerized units of polypropylene in the polypropylene homopolymer chain segments as a percentage of the total mole content of polymerized monomer units in the polypropylene copolymer; and
      ii) 5 to 50 weight percent of ethylene-containing copolymer chain segments based on the weight of the polypropylene copolymer; or 21 to 57 mole percent of ethylene-containing copolymer chain segments based on the mole content of polymerized monomer units in the ethylene-containing copolymer chain segments as a percentage of the total mole content of polymerized monomer units in the polypropylene copolymer;
      wherein at least a portion of the ethylene-containing copolymer chain segments comprise polymerized units of ethylene in an amount of at least 45 weight percent, based on the weight of the ethylene-containing copolymer chain segments; or at least 55 mole percent, based on the mole content of polymerized units of ethylene in the ethylene-containing copolymer chain segments as a percentage of the total mole content of polymerized monomer units in the ethylene-containing copolymer chain segments, and
      wherein the non-porous layer of polymer has a matrix phase of said polypropylene homopolymer chain segments, the matrix phase further having a plurality of domains of said ethylene-containing copolymer chain segments within said matrix phase, the domains of the ethylene-containing copolymer chain segments further comprising an inclusion phase, within said domains, of said polypropylene homopolymer chain segments, and
   b) the nonwoven substrate comprising a spunbonded nonwoven having a random network of continuous filaments of thermoplastic polymer bonded together at crossover points in the random network; the nonwoven substrate having
      (i) a basis weight of 30 to 100 gsm, and
      (ii) an elongation at break at room temperature of less than 50 percent;
B) subjecting the non-porous laminate to sequential cold and hot stretching steps comprising:
   (i) at least one cold stretching step of 20 to 50 percent at a temperature of less than 30° C.; and
   (ii) at least one hot stretching step of 20 to 50 percent at a temperature greater than 100° C.;
   to fracture the domains of said ethylene-containing copolymer chain segments within the matrix phase to form micropores in the non-porous layer of polymer and produce a microporous laminate.

This process is especially useful in making a one-layer microporous laminate, that is a microporous laminate comprising a single microporous polymeric surface coating on a nonwoven substrate. Alternatively, a related process is useful in making a microporous laminate having a single microporous polymeric surface coating on each of opposing sides of a nonwoven substrate (i.e., a two-layer microporous laminate). In this alternative process for forming a microporous laminate, the microporous laminated comprising a first microporous polymeric surface coating on a first surface of a nonwoven substrate, and a second microporous polymeric surface coating on an opposing second surface of a nonwoven substrate, comprises the steps of:
A) surface coating a first molten layer of polymer on the first surface of the nonwoven substrate, followed by cooling, and surface coating a second molten layer of polymer on the opposing second surface of the nonwoven substrate, also followed by cooling, to form a non-porous laminate having a first non-porous layer of said polymer on said first surface and a second non-porous layer of said polymer on said second opposing surface,
   each non-porous layer of polymer having an areal loading of 22.9 to 114.3 gsm and a thickness of 1-5 mils (25 to 125 micrometers), wherein:
   a) the polymer is a composition comprising polypropylene copolymer, said polypropylene copolymer comprising polypropylene homopolymer chain segments and ethylene-containing copolymer chain segments in an amount of:
      i) 50 to 95 weight percent polypropylene homopolymer chain segments, based on the weight of the polypropylene copolymer; or 43 to 79 mole percent polypropylene homopolymer chain segments, based on the mole content of polymerized units of polypropylene in the polypropylene homopolymer chain segments as a percentage of the total mole content of polymerized monomer units in the polypropylene copolymer; and
      ii) 5 to 50 weight percent of ethylene-containing copolymer chain segments based on the weight of the polypropylene copolymer; or 21 to 57 mole percent of ethylene-containing copolymer chain segments based on the mole content of polymerized monomer units in the ethylene-containing copolymer chain segments as a percentage of the total mole content of polymerized monomer units in the polypropylene copolymer;
      wherein at least a portion of the ethylene-containing copolymer chain segments comprise polymerized units of ethylene in an amount of at least 45 weight percent, based on the weight of the ethylene-containing copolymer chain segments; or at least 55 mole percent, based on the mole content of polymerized units of ethylene in the ethylene-containing copolymer chain segments as a percentage of the total mole content of polymerized monomer units in the ethylene-containing copolymer chain segments, and
      wherein each non-porous layer of polymer has a matrix phase of said polypropylene homopolymer chain segments, the matrix phase further having a plurality of domains of said ethylene-containing copolymer chain segments within said matrix phase, the domains of the ethylene-containing copolymer chain segments further comprising an inclusion phase, within said domains, of said polypropylene homopolymer chain segments, and
   b) the nonwoven substrate comprising a spunbonded nonwoven having a random network of continuous filaments of thermoplastic polymer bonded together at crossover points in the random network; the nonwoven substrate having
      (i) a basis weight of 30 to 100 gsm, and
      (ii) an elongation at break at room temperature of less than 50 percent;
B) subjecting the non-porous laminate to sequential cold and hot stretching steps comprising:
   (i) at least one cold stretching step of 20 to 50 percent at a temperature of less than 30° C.; and
   (ii) at least one hot stretching step of 20 to 50 percent at a temperature greater than 100° C.;
      to fracture the domains of said ethylene-containing copolymer chain segments within the matrix phase to form micropores in each non-porous layer of polymer and produce a microporous laminate.

As in the prior one-sided process, in some embodiments the thermoplastic polymer of the polymeric filaments of the nonwoven substrate comprises polypropylene, polyester, nylon, or a mixture thereof; and in some preferred embodiments, the thermoplastic polymer of the polymeric filaments of the nonwoven substrate comprises polypropylene.

The sequential cold and hot stretching steps of B) for either the one- or two-layer microporous laminate can be accomplished in a number of ways. In one embodiment, the stretching steps (i) and (ii) stretch the non-porous laminate solely in the machine direction. In another embodiment, the stretching step (i) stretches the non-porous laminate in the machine direction and stretching step (ii) stretches the non-porous laminate in the cross direction.

In some embodiments, sequential cold and hot stretching steps of B) comprise a single cold stretching step and multiple hot stretching steps, and the multiple hot stretching steps can be done sequentially solely in the machine direction or can be done in alternating sequential machine direction and transverse direction steps.

In some embodiments, the at least one cold stretching step (i) stretches the laminate 20 to 40 percent. In some embodiments, the at least one cold stretching step (i) stretches the laminate at a temperature of from about −20° C. to less than 30° C. In some embodiments, the at least one cold stretching step (i) stretches the laminate at a temperature of from about 15° C. to less than 30° C. In some embodiments, the at least one cold stretching step (i) stretches the laminate at a temperature of from about 15° C. to about 25 or 28° C.

In some embodiments, the at least one hot stretching step (ii) stretches the laminate 30 to 50 percent. In some embodiments, the at least one hot stretching step (ii) stretches the laminate at a temperature greater than 100° C. to about 150° C. In some embodiments, the at least one hot stretching step (ii) stretches the laminate at a temperature greater than 130° C. to about 150° C., and in some embodiments, the at least one hot stretching step (ii) stretches the laminate at a temperature greater than 140° C. to about 150° C.

In some embodiments, the extruded non-porous layer of polymer preferably has a thickness of 2-4 mils (50.8 to 101.6 micrometers) on the base substrate (that is, as applied to the substrate).

In some embodiments, the nonwoven substrate has a basis weight of 40 to 85 gsm. In some embodiments, the nonwoven substrate has an elongation at break at room temperature of 40 percent or less. In some embodiments, the nonwoven substrate has an elongation at break at room temperature of 20-50 percent, and in some embodiments, the nonwoven substrate has an elongation at break at room temperature of 20-40 percent.

In the extrusion lamination process, the polypropylene copolymer is melted, and the melted polypropylene copolymer formulation is then forced through a die to form a non-porous film or layer of polymer. This step can be performed using, for example, a single-screw or twin-screw extruder, an accumulating extruder, or other suitable apparatus, equipped with a suitable die such as a slit die or dog-bone die. The polypropylene copolymer is heated in the extrusion equipment to a temperature above the crystalline melting temperature of the polypropylene homopolymer of the continuous phase and forced through the die to form a layer of polymer. A preferred extrusion temperature is at least 180° C. or at least 200° C. and up to 240° C. or up to 260° C.

The molten non-porous layer of polypropylene copolymer is contacted with a surface of the non-woven substrate, to produce a non-porous polypropylene copolymer layer on that surface. This step is performed before the polypropylene copolymer non-porous polypropylene copolymer layer has cooled to below its Vicat softening temperature. The contacting step preferably is performed within 30 seconds, more preferably within 10 seconds, within 5 seconds or within 2 seconds from when the sheet exits the extruder die.

It is desirable that the contacting step be performed under very minor mechanical (nipping) pressure such that the polypropylene copolymer layer is preferably surface coated on the nonwoven substrate with limited intrusion into the nonwoven substrate below the surface. By “surface coating” it is meant the polypropylene copolymer layer is preferably primarily fused to continuous filaments on a surface of the nonwoven substrate. This means the polypropylene copolymer layer preferably does not embed into the nonwoven substrate more than about 25% of the initial thickness of the nonwoven substrate, preferably no more than about 10% of the initial thickness of the nonwoven substrate, and most preferably no more than about 5% of the initial thickness of the nonwoven substrate. Adequate mechanical (nipping) pressure is conveniently applied by passing the non-woven substrate and applied polypropylene copolymer layer through one or more calendar rollers; however other apparatus, such as a double-belt laminator are also suitable. In some embodiments one or more of the calendar rollers may be chilled to simultaneously cool the polyolefin to a temperature below its Vicat softening temperature (such as to 80 to 120° C.).

In some embodiments, the extrusion lamination process includes applying an extruded polypropylene copolymer layer to both sides of the non-woven substrate. In such instances, the opposing polypropylene copolymer layers can be contacted with the non-woven substrate simultaneously or sequentially.

Each extruded non-porous polypropylene copolymer layer, prior to any stretching, preferably has an areal loading (i.e., basis weight) of about 22.9 to 114.3 gsm and a thickness of 1-5 mils (25 to 125 micrometers),

The extruded non-porous polypropylene copolymer layer on the substrate is non-porous prior to the stretching steps. It is preferred to omit blowing agents and/or gasses in the extrusion process to avoid producing pores in the extruded non-porous polypropylene copolymer layer at this stage. For purposes of this invention, a sheet material is considered as “non-porous” if, after cooling, it exhibits a water vapor transmission rate (WVTR) of no greater than 2 g/m²-day at 37.8° C., 100% relative humidity, as measured according to ASTM D1249. Preferably, the molten extruded non-porous polypropylene copolymer layer is contacted with a surface of the nonwoven, and then cooled to below its Vicat softening temperature to produce a non-porous polymer layer coated on that surface, forming a non-porous monolithic sheet that can then be further stretched to develop the desired micropores.

The non-porous laminate thus formed is preferably cooled to a temperature of 50° C. or less before being subjected to the sequential cold and hot stretching process. The cold stretch in the machine direction is performed first, followed by the hot stretch in a transverse direction. The stretching process may be performed in the general manner and conditions described in US 2021/095110 A1. The cold stretching may be performed in a single step or in multiple increments. Stretch percentage is calculated as 100%×[(stretched film length−initial film length)÷initial film length)]. As used herein, a “single step” is considered a single stretching process for stretching a sheet material a certain amount in a particular direction at a particular temperature or range of temperatures. For example, a “single cold stretch step” may include multiple rolls that work together to incrementally stretch the sheet material with each roll to ultimately stretch the sheet material a certain desired percentage in one direction.

The cold stretched composite sheet can be optionally annealed prior to performing the subsequent hot stretching step if desired. Such an annealing step is conveniently performed by heating the cold stretched composite sheet to a temperature of 90 to 150° C., for a period of at least one second, preferably at 30 least 2 seconds. Annealing periods of more than 30 seconds are generally unnecessary. Annealing can fix the pore structure formed in the cold stretching step and also reduce shrinkage. The annealing step preferably is performed immediately after cold stretching while maintaining the cold stretched composite sheet under as much tension as required to prevent shrinkage prior to transverse stretching.

The hot stretching step is performed with the laminate at a temperature of greater than 100° C. in one or more steps in either the machine direction, the transverse direction, or both. When the laminate is stretched in the transverse direction, preferably the transverse direction is orthogonal to the cold machine direction stretching. The hot stretching may be performed in a single step or in multiple increments. And again, stretch percentage is calculated as 100%×[(stretched film length−initial film length)÷initial film length)] based on before and after hot stretching in a direction. The hot stretched composite sheet is optionally annealed in the same manner as described with regard to annealing the cold stretched composite sheet.

The transverse or cross direction is perpendicular (or orthogonal) to the machine direction (within the plane of the sheet). Either of the cold or hot stretching steps can be performed uniaxially in the machine direction or in the cross direction, but to create a biaxially-stretched microporous laminate, the cold and hot stretching steps should not be in the same direction, but preferably be orthogonal. In a preferred embodiment, the cold stretching step is performed in a machine direction and the hot stretching step is performed in the transverse or cross direction. When one of the stretching steps is performed in the machine direction and the other in the cross direction, the resulting microporous laminate can have more relatively balanced physical properties such as tensile strength and elongation in the machine and cross directions.

The non-porous laminate can be biaxially stretched in a continuous operation involving the combination of various devices that first stretch the non-porous laminate in the machine direction, for example a series of stretching rollers, followed by a stretching the non-porous laminate in the transverse or cross direction, such as with the use of a tenter frame that includes clips for gripping the sides of laminate The clips are mounted on a pair of rails that diverge in the direction of the movement of the laminate through the apparatus. The clips travel along the rails, carrying the laminate, diverging and thus biaxially stretching the non-porous laminate into a biaxially-stretched microporous laminate. The tenter frame is particularly well suited for stretching the sheet material in the cross direction. As before, the stretching section (i.e., the section that includes the diverging rails) can be preceded by a preheating section, which can be followed by an annealing section and/or a rewinding section.

Yet another suitable stretching apparatus is a grooved roller stretcher. Such a grooved roller stretcher is particularly useful for stretching the non-porous film or composite sheet in the cross direction. The grooved roller stretcher comprises interdigitating tooth-and-groove structures through which the non-porous film or composite sheet is passed. The tooth-and-groove structure may be roller pairs as described, for example, in U.S. Pat. Nos. 4,368,565, 5,028,289 and 6,843,949, US Published Patent Application No. 2006/0148354 and EP 927 096B1; or a toothed-and-grooved activation member and moving belt with complementary teeth-and grooves such as described in U.S. Pat. No. 8,337,190. The grooved roller stretcher may include multiple tooth-and-groove structures in series. The non-porous laminate is fed into the grooved roller stretcher and transported through the tooth-and-grooved structures, where the non-porous laminate is stretched transversely to the direction of its movement. The resulting microporous laminate is then removed from the apparatus.

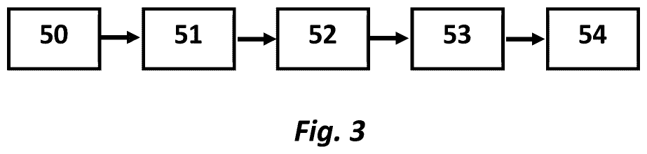

FIG. 3 is a representation of one possible continuous process for making a microporous laminate on an apparatus comprising an extrusion laminating device 50, followed by a cold-stretching device 51, followed by a hot-stretching device 52, followed by a cooling device 53, and finally a winding device 54. The extrusion laminating device 50 can include, for example, an extruder equipped with a die adapted to produce a non-porous layer of polymer, a feeding apparatus for supplying the nonwoven to a laminator, and a laminator such as heated calender rolls to contact the layer of polymer with a nonwoven. The extrusion laminating device can have heated or cooled calendar rolls as desired or needed. The extrusion laminating device can further include the equipment to produce or provide a second layer of polymer (i.e., a second extruder, casting die, laminating station, etc.) for contacting a second non-porous layer of polymer on the opposing side of the nonwoven in a similar manner to form a two-layered non-porous laminate, the nonwoven located between the two layers of polymer, forming a sandwich structure.

The cold-stretching device 51 can receive the non-porous laminate from the extrusion laminating device and continuously cold-stretch the non-porous laminate preferably in the machine direction, which can include chilled rolls or other equipment, if needed, to cool or bring the non-porous laminate to a specific stretching temperature, and one or more stretching rollers or sets of nipped rollers for stretching the non-porous laminate in the desired direction. This is considered a single stretching step herein.

The hot-stretching device 52 can receive the cold-stretched laminate from the cold-stretching device and continuously further hot-stretch the laminate in either the machine or transverse direction and can include heated rolls or other equipment to heat or bring the laminate to a specific stretching temperature. In the case of transverse stretching, equipment such as a traverse spreading rollers an/or a tenter frame for gripping and stretching the heated laminate in a direction transverse the machine direction can be used. This hot-stretching device can further include an optional annealing section after the stretching rollers for optionally annealing the microporous laminate at a desired temperature, for example with additional temperature-controlled rollers. This is considered a single hot-stretch step herein.

The cooling device 53 can receive the stretched microporous laminate from the hot-stretching device and continuously cool the laminate; the cooling device can include chilled rolls or other equipment, if needed, to cool the biaxially-stretched composite sheet to a desired final temperature for winding into a roll good. The winding device 54 then preferably winds the final microporous laminate onto a core to form a roll of the microporous laminate.

One alternate embodiment of the microporous laminate, the “higher-elongation substrate embodiment” is made using a nonwoven substrate having an elongation at break of 50 percent or greater (measured at room temperature), the microporous laminate preferably having a Gurley air permeability of 20 to 150 seconds/100 cm³ of air,

Specifically, the microporous laminate comprises a first microporous polymeric surface coating on a nonwoven substrate, the nonwoven substrate having a first surface and an opposing second surface;
the first microporous polymeric surface coating comprising polypropylene copolymer, said polypropylene copolymer comprising polypropylene homopolymer chain segments and ethylene-containing copolymer chain segments in an amount of:
   i) 50 to 95 weight percent polypropylene homopolymer chain segments, based on the weight of the polypropylene copolymer; or 43 to 79 mole percent polypropylene homopolymer chain segments, based on the mole content of polymerized units of polypropylene in the polypropylene homopolymer chain segments as a percentage of the total mole content of polymerized monomer units in the polypropylene copolymer; and
   ii) 5 to 50 weight percent of ethylene-containing copolymer chain segments based on the weight of the polypropylene copolymer; or 21 to 57 mole percent of ethylene-containing copolymer chain segments based on the mole content of polymerized monomer units in the ethylene-containing copolymer chain segments as a percentage of the total mole content of polymerized monomer units in the polypropylene copolymer.
      At least a portion of the ethylene-containing copolymer chain segments comprise polymerized units of ethylene in an amount of at least 45 weight percent, based on the weight of the ethylene-containing copolymer chain segments; or at least 55 mole percent, based on the mole content of polymerized units of ethylene in the ethylene-containing copolymer chain segments as a percentage of the total mole content of polymerized monomer units in the ethylene-containing copolymer chain segments. Additionally, the first microporous polymeric surface coating has a matrix phase of said polypropylene homopolymer chain segments, the matrix phase further having a plurality of domains of said ethylene-containing copolymer chain segments within said matrix phase. The domains of the ethylene-containing copolymer chain segments further comprising an inclusion phase, within said domains, of said polypropylene homopolymer chain segments; the domains of said ethylene-containing copolymer chain segments within the matrix phase are fractured to form micropores in the first microporous polymeric surface coating. The first microporous polymeric surface coating having the fractured domains of ethylene-containing copolymer chain segments has an average thickness of 0.5 to 3.0 mils (12.7 to 76.2 micrometers).

The nonwoven substrate comprises a spunbonded nonwoven, a meltblown nonwoven, or some combination of spunbonded and meltblown nonwoven layers; the nonwoven substrate comprising a random network of filaments or fibers of thermoplastic polymer bonded together, with the polypropylene copolymer of the first microporous polymeric surface coating fused to filaments or fibers on the first surface of the nonwoven substrate.

The microporous laminate has a Gurley air permeability of 20 to 150 seconds/100 cm³ of air, preferably, 20 to 100 seconds/100 cm³ of air.

In some embodiments, the thermoplastic polymer of the polymeric filaments or fibers of the nonwoven substrate having an elongation at break of 50 percent or greater (measured at room temperature) comprises polypropylene, polyester, nylon, or a mixture thereof. In some embodiments, the thermoplastic polymer of the polymeric filaments or fibers of the nonwoven substrate having an elongation at break of 50 percent or greater (measured at room temperature) comprises polyester.

The higher elongation substrate embodiment of the microporous laminate can have other desirable properties. Specifically, the microporous laminate can have a basis weight of 30 to 100 g/m², preferably 45 to 85 g/m². The microporous laminate can also have a thickness of 3 to 15 mils (0.076 to 0.381 mm), preferably 6 to 12 mils. The microporous laminate can further have a hydrostatic head of 2.5 meters or greater, preferably 3 meters or greater. The microporous laminate can also have a water vapor permeance of 200 g/(24 hr·m²) or greater, preferably 400 g/(24 hr·m²) or greater. The microporous laminate can further have a tensile strength of 10 lbs/inch (87.6 N/50 mm) or greater, preferably 15 lbs/inch (131.4 N/50 mm) or greater.

In some embodiments, the higher-elongation substrate embodiment of the microporous laminate has only the first microporous polymeric surface coating on one surface of the nonwoven substrate. In other embodiments the microporous laminate has the first microporous polymeric surface coating on a first surface of the nonwoven substrate and a second microporous polymeric surface coating on an opposing second surface of the nonwoven substrate, forming a sandwich structure with the two microporous polymeric surface coating forming the outside surfaces of the laminate. That is, in the sandwich structure, in some preferred embodiments, the nonwoven substrate forms the center layer of the microporous laminate.

Preferably the second microporous polymeric surface coating is the same as the first microporous polymeric surface coating; that is, both surface coatings have essentially the same composition, thickness, and pore structure, or any differences in these parameters are minor and both surface coatings function the same in the desired application, and both are attached their respective surfaces of the nonwoven in the same way. Preferably, the two-layer higher-elongation substrate embodiment of the microporous laminate has a Gurley air permeability of 20 to 150 seconds/100 cm³ of air preferably 20 to 100 seconds/100 cm³ of air.

The two-layer higher-elongation substrate embodiment of the microporous laminate can have other desirable properties. Specifically, the microporous laminate can have a basis weight of 30 g/m² to 100 g/m², preferably 45 g/m² to 85 g/m². The microporous laminate can also have a thickness of 4 to 19 mils (0.10 to 0.48 mm), preferably 8 to 15 mils. The microporous laminate can further have a hydrostatic head of 3 meters or greater, preferably 3.5 meters or greater. The microporous laminate can also have a water vapor permeance of 200 g/(24 hr·m²) or greater, preferably 400 g/(24 hr·m²) or greater. The microporous laminate can further have a tensile strength of 10 lbs/inch (87.6 N/50 mm) or greater, preferably 15 lbs/inch (131.4/50 mm) or greater.

The compositions and morphology of the microporous polymeric surface coating of this higher-elongation substrate embodiment of the microporous laminate are the same as the polypropylene copolymer comprising polypropylene homopolymer chain segments and ethylene-containing copolymer chain segments, as previous stated herein for the lower-elongation substrate embodiment of the microporous laminate. All other elements described for the lower elongation substrate embodiment of the microporous laminate can also apply to the higher-elongation embodiment of the microporous laminate, except where stated otherwise herein.

Likewise, all of the nonwoven substrate details and definitions previously stated herein can be applied to this higher elongate substrate embodiment, except where stated otherwise herein.

The processes for making the higher elongation substrate embodiment of the microporous laminate, including processes for making both the laminates having at least one polymeric surface coating and laminates having two opposing polymeric surface coatings, are similar to the processes for making the lower elongation substrate embodiment previous disclosed herein, except where stated otherwise herein.

Therefore, one embodiment of the process for making the higher-elongation embodiment of the microporous laminate is made using a nonwoven substrate having an elongation at break of 50 percent or greater (measured at room temperature), the microporous laminate preferably having a Gurley air permeability of 20 to 150 seconds/100 cm³ of air.

Specifically, the embodiment being a process for forming a microporous laminate, the microporous laminated comprising a first microporous polymeric surface coating on a first surface of a nonwoven substrate, the process comprising the steps of:
A) surface coating a molten layer of polymer on the first surface of the nonwoven substrate, followed by cooling, to form a non-porous laminate having a non-porous layer of said polymer on said first surface,
   the non-porous layer of polymer having an areal loading of 22.9 to 114.3 gsm and a thickness of 1-5 mils (25 to 125 micrometers), wherein:
   a) the polymer is a composition comprising polypropylene copolymer, said polypropylene copolymer comprising polypropylene homopolymer chain segments and ethylene-containing copolymer chain segments in an amount of:
      i) 50 to 95 weight percent polypropylene homopolymer chain segments, based on the weight of the polypropylene copolymer; or 43 to 79 mole percent polypropylene homopolymer chain segments, based on the mole content of polymerized units of polypropylene in the polypropylene homopolymer chain segments as a percentage of the total mole content of polymerized monomer units in the polypropylene copolymer; and
      ii) 5 to 50 weight percent of ethylene-containing copolymer chain segments based on the weight of the polypropylene copolymer; or 21 to 57 mole percent of ethylene-containing copolymer chain segments based on the mole content of polymerized monomer units in the ethylene-containing copolymer chain segments as a percentage of the total mole content of polymerized monomer units in the polypropylene copolymer;
      wherein at least a portion of the ethylene-containing copolymer chain segments comprise polymerized units of ethylene in an amount of at least 45 weight percent, based on the weight of the ethylene-containing copolymer chain segments; or at least 55 mole percent, based on the mole content of polymerized units of ethylene in the ethylene-containing copolymer chain segments as a percentage of the total mole content of polymerized monomer units in the ethylene-containing copolymer chain segments, and
      wherein the non-porous layer of polymer has a matrix phase of said polypropylene homopolymer chain segments, the matrix phase further having a plurality of domains of said ethylene-containing copolymer chain segments within said matrix phase, the domains of the ethylene-containing copolymer chain segments further comprising an inclusion phase, within said domains, of said polypropylene homopolymer chain segments, and
   b) the nonwoven substrate comprising a random network of filaments or fibers of thermoplastic polymer bonded together in the form of a spunbonded nonwoven, a meltblown nonwoven, or some combination of spunbonded and meltblown nonwoven layers; the nonwoven substrate having
      (i) a basis weight of 30 to 100 gsm, and
      (ii) an elongation at break at room temperature of 50 percent or greater;
B) subjecting the non-porous laminate to sequential cold and hot stretching steps comprising:
   (i) at least one cold stretching step of 50 to 85 percent at a temperature of less than 30° C.; and
   (ii) at least one hot stretching step of 100 to 150 percent at a temperature greater than 100° C.;
      to fracture the domains of said ethylene-containing copolymer chain segments within the matrix phase to form micropores in the non-porous layer of polymer and produce the microporous laminate.

Another embodiment of the process for making the higher-elongation embodiment of the microporous laminate, made using a nonwoven substrate having an elongation at break of 50 percent or greater (measured at room temperature), has two opposing polymer layers, and the microporous laminate preferably has a Gurley air permeability of 20 to 150 seconds/100 cm³ of air.

Specifically, that embodiment being a process for forming a microporous laminate, the microporous laminated comprising a first microporous polymeric surface coating on a first surface of a nonwoven substrate, and a second microporous polymeric surface coating on an opposing second surface of a nonwoven substrate, the process comprising the steps of:
A) surface coating a first molten layer of polymer on the first surface of the nonwoven substrate, followed by cooling, and surface coating a second molten layer of polymer on the opposing second surface of the nonwoven substrate, also followed by cooling, to form a non-porous laminate having a first non-porous layer of said polymer on said first surface and a second non-porous layer of said polymer on said second opposing surface,
   each non-porous layer of polymer having an areal loading of 22.9 to 114.3 gsm and a thickness of 1-5 mils (25 to 125 micrometers), wherein:
   a) the polymer is a composition comprising polypropylene copolymer, said polypropylene copolymer comprising polypropylene homopolymer chain segments and ethylene-containing copolymer chain segments in an amount of:
      i) 50 to 95 weight percent polypropylene homopolymer chain segments, based on the weight of the polypropylene copolymer; or 43 to 79 mole percent polypropylene homopolymer chain segments, based on the mole content of polymerized units of polypropylene in the polypropylene homopolymer chain segments as a percentage of the total mole content of polymerized monomer units in the polypropylene copolymer; and
      ii) 5 to 50 weight percent of ethylene-containing copolymer chain segments based on the weight of the polypropylene copolymer; or 21 to 57 mole percent of ethylene-containing copolymer chain segments based on the mole content of polymerized monomer units in the ethylene-containing copolymer chain segments as a percentage of the total mole content of polymerized monomer units in the polypropylene copolymer;
      wherein at least a portion of the ethylene-containing copolymer chain segments comprise polymerized units of ethylene in an amount of at least 45 weight percent, based on the weight of the ethylene-containing copolymer chain segments; or at least 55 mole percent, based on the mole content of polymerized units of ethylene in the ethylene-containing copolymer chain segments as a percentage of the total mole content of polymerized monomer units in the ethylene-containing copolymer chain segments, and
      wherein each non-porous layer of polymer has a matrix phase of said polypropylene homopolymer chain segments, the matrix phase further having a plurality of domains of said ethylene-containing copolymer chain segments within said matrix phase, the domains of the ethylene-containing copolymer chain segments further comprising an inclusion phase, within said domains, of said polypropylene homopolymer chain segments, and
   b) the nonwoven substrate comprising a spunbonded nonwoven having a random network of filaments or fibers of thermoplastic polymer bonded together at crossover points in the random network; the nonwoven substrate having
      (i) a basis weight of 30 to 100 gsm, and
      (ii) an elongation at break at room temperature of 50 percent or greater;
B) subjecting the non-porous laminate to sequential cold and hot stretching steps comprising:
   (i) at least one cold stretching step of 50 to 85 percent at a temperature of less than 30° C.; and
   (ii) at least one hot stretching step of 100 to 150 percent at a temperature greater than 100° C.;
      to fracture the domains of said ethylene-containing copolymer chain segments within the matrix phase to form micropores in each non-porous layer of polymer and produce a microporous laminate.

As in the prior process for the lower elongation substrate embodiment, in some embodiments of the higher-elongation substrate embodiment, the thermoplastic polymer of the polymeric filaments of the nonwoven substrate comprises polypropylene, polyester, nylon, or a mixture thereof; and in some preferred embodiments, the thermoplastic polymer of the polymeric filaments of the nonwoven substrate comprises polyester.

The sequential cold and hot stretching steps of B) can be accomplished in a number of ways. In one embodiment, the stretching steps (i) and (ii) stretch the non-porous laminate solely in the machine direction. In another embodiment, the stretching step (i) stretches the non-porous laminate in the machine direction and stretching step (ii) stretches the non-porous laminate in the cross direction.

In some embodiments, sequential cold and hot stretching steps of B) comprise a single cold stretching step and multiple hot stretching steps, and the multiple hot stretching steps can be done sequentially solely in the machine direction or can be done in alternating sequential machine direction and transverse direction steps.

In some embodiments, the at least one cold stretching step (i) stretches the laminate 50 to 70 percent. In some embodiments, the at least one cold stretching step (i) stretches the laminate at a temperature of from about −20° C. to less than 30° C. In some embodiments, the at least one cold stretching step (i) stretches the laminate at a temperature of from about 15° C. to less than 30° C. In some embodiments, the at least one cold stretching step (i) stretches the laminate at a temperature from about 15° C. to about 25 or 28° C.

In some embodiments, the at least one hot stretching step (ii) stretches the laminate 50 to 125 percent. In some embodiments, the at least one hot stretching step (ii) stretches the laminate at a temperature greater than 100° C. to about 150° C. In some embodiments, the at least one hot stretching step (ii) stretches the laminate at a temperature greater than 130° C. to about 150° C. In some embodiments, the at least one hot stretching step (ii) stretches the laminate in at least two steps, wherein the first step has a temperature lower than the second step, with the temperatures in both steps being greater than about 100° C. as high as about 150° C. Additionally, the amount of stretch can be different in the two steps, with the first step having starting at a low percentage stretch of 50 to 70 percent and the second stretching step stretching at 100 to 150 percent; and each of the two hot stretch steps can be orthogonal to each other if desired.

In some embodiments, the extruded non-porous layer of polymer preferably has a thickness of 2-4 mils (50.8 to 101.6 micrometers) on the base substrate (that is, as applied to the substrate).

In some embodiments, the nonwoven substrate has a basis weight of 40 to 85 gsm. In some embodiments, the nonwoven substrate has an elongation at break at room temperature of 40 percent or less. In some embodiments, the nonwoven substrate has an elongation at break at room temperature of 20-50 percent, and in some embodiments, the nonwoven substrate has an elongation at break at room temperature of 20-40 percent.

### Test Methods

Melting and glass transition temperatures were determined by Differential Scanning calorimetry (DSC) as follows. A sample to be measured was weighed and sealed in aluminum hermetic DSC pans (P/N 900793.901 pan and 900794.901 lid). The sample weights were roughly 1-4 mg for each sample. The 15 samples were scanned in a TA Instruments Q2000 DSC (Differential Scanning calorimeter) (P/N 970001.901) (S/N 2000.0877) with an auto sampler, nitrogen purge of 50 ml/min and mechanical cooling accessory. The run parameters were −20° C. to 200° C. at 10° C./min with a sampling interval of 0.1 s/pt. for a heat-cool-heat cycle. The scans were analyzed using Universal Analysis V4.7A TA 20 Instruments software. Melting temperature was obtained from DSC scans presented as the output of the instrument software and correspond to the temperature of the peak in the heat flow versus temperature plot on the second heating cycle. Glass transition temperature was determined from the inflection point on second heatup of the DSC curve using a heating/cooling rate of 10 25° C./min.

Densities were determined by ASTM D792.

Softening point temperatures were determined by ASTM D36-06. Specific VICAT softening temperatures were determined by ASTM D1525.

The Melt (Mass) Flow Rate (MFR) was measured at 230° C. and 2.16 kg according to ASTM D-1238, in accordance with either Condition L (at 230° C. and 2.16 kg), or Condition E (at 190° C. and 2.16 kg) as noted.

Average molecular weight was measured via Gel Permeation Chromatography (GPC) as described in US20210095110A1.

Polymer composition was determined by Nuclear Magnetic Resonance 20 (NMR) Spectroscopy as described in US20210095110A1.

Thicknesses and basis weights were determined by ASTM D1777 and TAPPI T-410, respectively.

Trapezoid Tear was determined by ASTM D5587.

Breaking strength and elongation at break were determined by ASTM D882. For the determination of elongation at break at room temperature, it is assumed “room temperature” is the ambient temperature, generally 22° C. (+/−2.5° C.).

Water Vapor Permeance was the wet cup determination at a temperature of 23° C.±0.6° C. and RH difference of 50±2%.

Gurley Air Permeability was determined by TAPPI T-460 and breaking strength and elongation at break were determined by ASTM D882.

Water Holdout was determined by AATCC 127-1995 (Dynamic 60 millibar/minute up to 1000 millibar or failure (3 pinholes)).

### Example 1

Microporous laminates comprising a microporous polymeric surface coating on a nonwoven substrate, that were suitable as house wrap or roofing sheeting, were made. The microporous polymeric surface coating was a reactor grade polypropylene copolymer resin manufactured by Braskem having 67.1 weight percent homopolymer chain segments and 32.9 weight percent ethylene-propylene copolymer chain segments, with the ethylene content in ethylene-propylene copolymer chain segments being 49.7 weight percent. The polypropylene copolymer resin had a density of 0.9 g/cm³ and a melt index of 7 g/10 min at 230° C. and 2.16 kg. The number average molecular weight (Mn) and the weight average molecular weight (Mw) of the polypropylene copolymer resin was 58,000 and 295,000, respectively.

For each laminate of this example, the polypropylene copolymer was extrusion coated onto an 80 gsm Typar® polypropylene nonwoven having an elongation at break at room temperature of 40%. For Item 1.1, one layer of polypropylene copolymer was coated on one side of the substrate to form a non-porous laminate. For Item 1.2, one layer of polypropylene copolymer was coated on opposing sides of the substrate to form a non-porous laminate.

The non-porous laminates then underwent machine-direction orientation (MDO) by cold stretching (20-30%) at less than 30° C. (i.e., at room temperature without prior pre-heating), followed by transverse-direction orientation (TDO) by hot stretching (30-40%) at 148° C., as shown in Table 1, to form microporous laminates.

As shown in Table 2, both microporous laminates exhibited a low water vapor permeance (WVP) of about 50 g/(24 h·m²) and high tear resistance of 30-45 lbs in both MD and CD directions. The breaking strength was also about 27-37 lbs/in.

TABLE 1

| | | | Degree of | | | |
|---|---|---|---|---|---|---|
| | Applied | | MDO Cold | Degree of | | |
| | Coating | | Stretching at | TDO Hot | Final | |
| | Layer | Number of | Room | Stretching | Laminate | Basis |
| | Thickness | Coating | Temperature | at 148° C. | Thickness | Weight |
| Item | (mil) | Layers | (%) | (%) | (mil) | (g/m²) |
| 1.1 | 3 | 1 | 30 | 30 | 12.4 | 126.6 |
| 1.2 | 2 | 2 | 20 | 40 | 11.2 | 133.1 |

TABLE 2

| | | Trapezoid | | | | | |
|---|---|---|---|---|---|---|---|
| | | Tear | | Breaking | | Elongation at | |
| | | Resistance | | Strength | | Break | |
| | WVP | (lbs) | | (lbs/in) | | (%) | |
| Item | (g/24 h-m²) | MD | CD | MD | CD | MD | CD |
| 1.1 | 52.5 | 33.6 | 45.6 | 36.8 | 26.9 | 84.4 | 54.4 |
| 1.2 | 44.4 | 31.7 | 32.4 | 35.6 | 27.3 | 73.4 | 52.7 |

### Example 2

Microporous laminates comprising a microporous polymeric surface coating on a nonwoven substrate, that were suitable as house wrap or roofing sheeting, were made. The reactor grade polypropylene copolymer resin of Example 1 was used, however, the resin further contained 1.5% of an ultraviolet light stabilizer.

For each laminate of this example, polypropylene copolymer was extrusion coated onto a 45 gsm Typar® polypropylene nonwoven having an elongation at break at room temperature of 30%. Each individual layer of polypropylene copolymer had a coated thickness, prior to any stretching, of 2.5 mils. For Items 2.1 & 2.2, one layer of the polypropylene copolymer was coated on one side of the substrate to form a non-porous laminate, using an extrusion temperature of 240° C. and a nip pressure of 1 bar. For Item 2.3 one layer of polypropylene copolymer was coated on one side of the substrate to form a non-porous laminate, using an extrusion temperature of 240° C. and a nip pressure of 2.2 bar. For Items 2.4 & 2.5, one layer of polypropylene copolymer was coated on opposing sides of the substrate to form a non-porous laminate, using an extrusion temperature of 240° C. and a nip pressure of 2.2 bar.

As shown in Table 3, the non-porous laminates were then subjected to 30-40% MDO cold stretching at less than 30° C. (i.e., at room temperature without prior pre-heating), followed by subsequent 40-50% TDO hot stretching at 143° C. The basis weight of final of these microporous laminates ranged from about 65 gsm to 95 gsm.

All of the microporous laminates exhibited a Gurley air permeability of much greater than 1000 s/100 cm³ of air. As shown in Table 4, water holdout (hydrohead) was greater than 450 mbar for all of the microporous laminates. The microporous laminates also exhibited a water vapor permeance (WVP) of about 140 to 300 g/(24 h·m²) and high tear resistance of above about 9.5 lbs-force in both MD and CD directions.

TABLE 3

| | | | Degree of | | | |
|---|---|---|---|---|---|---|
| | Applied | | MDO Cold | Degree of | | |
| | Coating | Number | Stretching at | TDO Hot | Final | |
| | Layer | of | Room | Stretching | Laminate | Basis |
| | Thickness | Coating | Temperature | at 143° C. | Thickness | Weight |
| Item | (mil) | Layers | (%) | (%) | (mil) | (g/m²) |
| 2.1 | 2.5 | 1 | 30 | 40 | 9.2 | 71.3 |
| 2.2 | 2.5 | 1 | 30 | 50 | 9.8 | 68.2 |
| 2.3 | 2.5 | 1 | 30 | 50 | 11.0 | 65.9 |
| 2.4 | 2.5 | 2 | 40 | 40 | 8.0 | 94.6 |
| 2.5 | 2.5 | 2 | 40 | 50 | 8.4 | 90.7 |

TABLE 4

| | | | | | | | | | Trapezoid | |
|---|---|---|---|---|---|---|---|---|---|---|
| | | | Breaking | | Elongation | | Young's | | Tear | |
| | Water | | Strength | | at Break | | Modulus | | Resistance | |
| | Holdout | WVP | (lbs/in) | | (%) | | (MPa) | | (lbs-force) | |
| Item | (mbar) | (g/24 h-m²) | MD | CD | MD | CD | MD | CD | MD | CD |
| 2.1 | 576 | 182.8 | 15.9 | 14.3 | 47.0 | 30.4 | 122.3 | 133.4 | 11.2 | 15.5 |
| 2.2 | 524 | 284.0 | 15.8 | 16.0 | 54.0 | 38.0 | 113.4 | 131.8 | 13.9 | 14.8 |
| 2.3 | 490 | 146.8 | 16.0 | 12.6 | 67.7 | 44.7 | 116.6 | 96.3 | 13.6 | 9.6 |
| 2.4 | 609 | 164.9 | 28.8 | 17.7 | 20.7 | 35.7 | 259.1 | 180.0 | 11.4 | 12.0 |
| 2.5 | 715 | 235.7 | 25.7 | 18.8 | 23.7 | 29.4 | 237.4 | 168.1 | 11.2 | 14.7 |

### Example 3

Microporous laminates comprising a microporous polymeric surface coating on a nonwoven substrate, that were suitable for certain medical applications such as for table covers, were made. The reactor grade polypropylene copolymer resin of Example 1 was used, however, the resin further contained a FDA-approved blue colorant, as medical applications prefer that color.

For each laminate of this example, the polypropylene copolymer was extrusion coated onto 50 gsm spunbonded polypropylene (SBPP) nonwoven having an elongation at break at room temperature of greater than 50%, available from Acme Mills Company, 33 Bloomfield Hills Pkwy #120, Bloomfield Hills, MI 48304. Upon inspection, the nonwoven substrate was heat fused in a crosshatch pattern of small, localized areas each about 0.31 mm² and spaced so that about 15% of the fiber sheet surface area was fused. The areal density of the fused areas was approximately three per square centimeter. This SBPP had a higher elongation at break at room temperature than the polypropylene nonwoven of Examples 1 & 2; the nonwoven filaments in the SBPP nonwoven having a much smaller diameter relative to the filaments present in the Examples 1 & 2 nonwoven materials. For Item 3.1, one layer of polypropylene copolymer was coated on one side of the substrate to form a dark blue non-porous laminate. For Items 3.2 to 3.5, one layer of polypropylene copolymer was coated on opposing sides of the substrate to form a dark blue non-porous laminate.

As shown in Table 5, the non-porous laminates were then subjected to 50-70% MDO cold stretching at less than 30° C. (i.e., at room temperature without prior pre-heating), followed by 50% MDO hot stretching at 130° C. (except for Item 3.2), followed by subsequent 100-125% TDO hot stretching at 148° C. The basis weight of final products ranged from about 45 gsm to 80 gsm. As the laminate was stretched, the blue color of the coated layer(s) lightened.

As shown in Table 6, most of the microporous laminates exhibited a Gurley air permeability of less than 100 s/100 cm³ of air, meaning they have an exceedingly high flux, while surprisingly having a high water holdout (hydrohead); with the microporous laminates made with 3 mil coating layers having at least a 450 mbar water holdout, while the microporous laminates made with 4 mil coating layers having at least an 840 mbar water holdout. These samples had a water vapor permeance (WVP) of about 900 g/(24 h·m²) on average.

TABLE 5

| | | | Degree of | | | | |
|---|---|---|---|---|---|---|---|
| | Applied | | MDO Cold | Degree of | Degree of | | |
| | Coating | Number | Stretching at | MDO Hot | TDO Hot | Final | |
| | Layer | of | Room | Stretching | Stretching | Laminate | Basis |
| | Thickness | Coating | Temperature | at 130° C. | at 148° C. | Thickness | Weight |
| Item | (mil) | Layers | (%) | (%) | (%) | (mil) | (g/m²) |
| 3.1 | 4 | 1 | 50 | 50 | 100 | 6.4 | 45.9 |
| 3.2 | 3 | 2 | 70 | — | 125 | 7.3 | 74.3 |
| 3.3 | 3 | 2 | 70 | 50 | 125 | 6.0 | 58.3 |
| 3.4 | 4 | 2 | 50 | 50 | 125 | 8.0 | 74.3 |
| 3.5 | 4 | 2 | 70 | 50 | 100 | 8.4 | 81.4 |

TABLE 6

| | Gurley Air | | | Breaking | | Elongation | |
|---|---|---|---|---|---|---|---|
| | Permeability | Water | | Strength | | at Break | |
| | (s/100 cm³ | Holdout | WVP | (lbs/in) | | (%) | |
| Item | of air) | (mbar) | (g/24 h-m²) | MD | CD | MD | CD |
| 3.1 | 36.9 | 878 | 904.8 | 12.4 | 7.1 | 13.7 | 10.0 |
| 3.2 | 115.1 | 458 | 918.6 | 15.7 | 13.8 | 22.7 | 7.7 |
| 3.3 | 45.8 | 449 | 969.7 | 15.9 | 8.4 | 11.4 | 8.7 |
| 3.4 | 58.3 | 843 | 926.3 | 19.1 | 12.2 | 13.4 | 9.0 |
| 3.5 | 66.4 | >1000 | 876.4 | 19.3 | 12.1 | 12.0 | 10.7 |

1. A microporous laminate comprising a first microporous polymeric surface coating on a nonwoven substrate, the nonwoven substrate having a first surface and an opposing second surface;
the first microporous polymeric surface coating comprising polypropylene copolymer, said polypropylene copolymer comprising polypropylene homopolymer chain segments and ethylene-containing copolymer chain segments in an amount of:
i) 50 to 95 weight percent polypropylene homopolymer chain segments, based on the weight of the polypropylene copolymer; or 43 to 79 mole percent polypropylene homopolymer chain segments, based on the mole content of polymerized units of polypropylene in the polypropylene homopolymer chain segments as a percentage of the total mole content of polymerized monomer units in the polypropylene copolymer; and
ii) 5 to 50 weight percent of ethylene-containing copolymer chain segments based on the weight of the polypropylene copolymer; or 21 to 57 mole percent of ethylene-containing copolymer chain segments based on the mole content of polymerized monomer units in the ethylene-containing copolymer chain segments as a percentage of the total mole content of polymerized monomer units in the polypropylene copolymer;
wherein at least a portion of the ethylene-containing copolymer chain segments comprise polymerized units of ethylene in an amount of at least 45 weight percent, based on the weight of the ethylene-containing copolymer chain segments; or at least 55 mole percent, based on the mole content of polymerized units of ethylene in the ethylene-containing copolymer chain segments as a percentage of the total mole content of polymerized monomer units in the ethylene-containing copolymer chain segments;
wherein the first microporous polymeric surface coating has a matrix phase of said polypropylene homopolymer chain segments, the matrix phase further having a plurality of domains of said ethylene-containing copolymer chain segments within said matrix phase,
the domains of the ethylene-containing copolymer chain segments further comprising an inclusion phase, within said domains, of said polypropylene homopolymer chain segments,
wherein the domains of said ethylene-containing copolymer chain segments within the matrix phase are fractured to form micropores in the first microporous polymeric surface coating, the first microporous polymeric surface coating having said fractured domains of ethylene-containing copolymer chain segments having an average thickness of 0.4 to 3.9 mils (10 to 100 micrometer), and
wherein the nonwoven substrate comprises a spunbonded nonwoven having a random network of continuous filaments of thermoplastic polymer bonded together at crossover points in the random network;
wherein the polypropylene copolymer of the first microporous polymeric surface coating is fused to continuous filaments on the first surface of the nonwoven substrate; and
wherein the microporous laminate has a trapezoid tear of 40 to 225 Newtons (9 to 50 lbs-force).

2. The microporous laminate of claim 1, wherein the thermoplastic polymer of the polymeric filaments of the nonwoven substrate comprises polypropylene, polyester, nylon, or a mixture thereof.

3. The microporous laminate of claim 2, wherein the thermoplastic polymer comprises polypropylene

4. The microporous laminate of claim 1 further having:
(i) a basis weight of 30 g/m² to 120 g/m²,
(ii) a thickness of 3 to 15 mils (0.076 to 0.381 mm),
(iii) a hydrostatic head of 2 meters or greater,
(iv) a water vapor permeance of 18 g/(24 hr·m²) or greater, and
(v) a tensile strength of 10 lbs/inch (87.6 N/50 mm) or greater.

6. The microporous laminate of claim 1, further comprising a second microporous polymeric surface coating,
said second microporous polymeric surface coating being the same as the first microporous polymeric surface coating, and
wherein the polypropylene copolymer of the second microporous polymeric surface coating is fused to continuous filaments on the opposing second surface of the nonwoven substrate.

7. The microporous laminate of claim 6 further having:
(i) a basis weight of 40 g/m² to 150 g/m²,
(ii) a thickness of 4 to 19 mils (0.10 to 0.48 mm),
(iii) a hydrostatic head of 3 meters or greater,
(iv) a water vapor permeance of 25 g/(24 hr·m²) or greater, and
(v) a tensile strength of 10 lbs/inch (87.6 N/50 mm) or greater.

8. A process for forming a microporous laminate, the microporous laminated comprising a first microporous polymeric surface coating on a nonwoven substrate, the nonwoven substrate having a first surface and an opposing second surface, the process comprising the steps of:
A) surface coating a molten layer of polymer on the first surface of the nonwoven substrate, followed by cooling, to form a non-porous laminate having a non-porous layer of said polymer on said first surface, the non-porous layer of polymer having an areal loading of 22.9 to 114.3 gsm and a thickness of 1-5 mils (25 to 125 micrometers), wherein:
a) the polymer is a composition comprising polypropylene copolymer, said polypropylene copolymer comprising polypropylene homopolymer chain segments and ethylene-containing copolymer chain segments in an amount of:
i) 50 to 95 weight percent polypropylene homopolymer chain segments, based on the weight of the polypropylene copolymer; or 43 to 79 mole percent polypropylene homopolymer chain segments, based on the mole content of polymerized units of polypropylene in the polypropylene homopolymer chain segments as a percentage of the total mole content of polymerized monomer units in the polypropylene copolymer; and
ii) 5 to 50 weight percent of ethylene-containing copolymer chain segments based on the weight of the polypropylene copolymer; or 21 to 57 mole percent of ethylene-containing copolymer chain segments based on the mole content of polymerized monomer units in the ethylene-containing copolymer chain segments as a percentage of the total mole content of polymerized monomer units in the polypropylene copolymer;
wherein at least a portion of the ethylene-containing copolymer chain segments comprise polymerized units of ethylene in an amount of at least 45 weight percent, based on the weight of the ethylene-containing copolymer chain segments; or at least 55 mole percent, based on the mole content of polymerized units of ethylene in the ethylene-containing copolymer chain segments as a percentage of the total mole content of polymerized monomer units in the ethylene-containing copolymer chain segments, and
wherein the non-porous layer of polymer has a matrix phase of said polypropylene homopolymer chain segments, the matrix phase further having a plurality of domains of said ethylene-containing copolymer chain segments within said matrix phase, the domains of the ethylene-containing copolymer chain segments further comprising an inclusion phase, within said domains, of said polypropylene homopolymer chain segments, and
b) the nonwoven substrate comprising a spunbonded nonwoven having a random network of continuous filaments of thermoplastic polymer bonded together at crossover points in the random network; the nonwoven substrate having
(i) a basis weight of 30 to 100 gsm, and
(ii) an elongation at break at room temperature of less than 50 percent;
B) subjecting the non-porous laminate to sequential cold and hot stretching steps comprising:
(i) at least one cold stretching step of 20 to 50 percent at a temperature of less than 30° C.; and
(ii) at least one hot stretching step of 20 to 50 percent at a temperature greater than 100° C.;
to fracture the domains of said ethylene-containing copolymer chain segments within the matrix phase to form micropores in the non-porous layer of polymer and produce a microporous laminate.

9. A process for forming a microporous laminate, the microporous laminated comprising a first microporous polymeric surface coating on a first surface of a nonwoven substrate, and a second microporous polymeric surface coating on an opposing second surface of a nonwoven substrate,
the process comprising the steps of:
A) surface coating a first molten layer of polymer on the first surface of the nonwoven substrate, followed by cooling, and surface coating a second molten layer of polymer on the opposing second surface of the nonwoven substrate, also followed by cooling, to form a non-porous laminate having a first non-porous layer of said polymer on said first surface and a second non-porous layer of said polymer on said second opposing surface, each non-porous layer of polymer having an areal loading of 22.9 to 114.3 gsm and a thickness of 1-5 mils (25 to 125 micrometers), wherein:
a) the polymer is a composition comprising polypropylene copolymer, said polypropylene copolymer comprising polypropylene homopolymer chain segments and ethylene-containing copolymer chain segments in an amount of:
i) 50 to 95 weight percent polypropylene homopolymer chain segments, based on the weight of the polypropylene copolymer; or 43 to 79 mole percent polypropylene homopolymer chain segments, based on the mole content of polymerized units of polypropylene in the polypropylene homopolymer chain segments as a percentage of the total mole content of polymerized monomer units in the polypropylene copolymer; and
ii) 5 to 50 weight percent of ethylene-containing copolymer chain segments based on the weight of the polypropylene copolymer; or 21 to 57 mole percent of ethylene-containing copolymer chain segments based on the mole content of polymerized monomer units in the ethylene-containing copolymer chain segments as a percentage of the total mole content of polymerized monomer units in the polypropylene copolymer;
wherein at least a portion of the ethylene-containing copolymer chain segments comprise polymerized units of ethylene in an amount of at least 45 weight percent, based on the weight of the ethylene-containing copolymer chain segments; or at least 55 mole percent, based on the mole content of polymerized units of ethylene in the ethylene-containing copolymer chain segments as a percentage of the total mole content of polymerized monomer units in the ethylene-containing copolymer chain segments, and
wherein each non-porous layer of polymer has a matrix phase of said polypropylene homopolymer chain segments, the matrix phase further having a plurality of domains of said ethylene-containing copolymer chain segments within said matrix phase, the domains of the ethylene-containing copolymer chain segments further comprising an inclusion phase, within said domains, of said polypropylene homopolymer chain segments, and
b) the nonwoven substrate comprising a spunbonded nonwoven having a random network of continuous filaments of thermoplastic polymer bonded together at crossover points in the random network; the nonwoven substrate having
(i) a basis weight of 30 to 100 gsm, and
(ii) an elongation at break at room temperature of less than 50 percent;
B) subjecting the non-porous laminate to sequential cold and hot stretching steps comprising:
(i) at least one cold stretching step of 20 to 50 percent at a temperature of less than 30° C.; and
(ii) at least one hot stretching step of 20 to 50 percent at a temperature greater than 100° C.;
to fracture the domains of said ethylene-containing copolymer chain segments within the matrix phase to form micropores in each non-porous layer of polymer and produce a microporous laminate.

10. The process of claim 8, wherein stretching steps (i) and (i) stretch the non-porous laminate solely in the machine direction.

11. The process of claim 8, wherein stretching step (i) stretches the non-porous laminate in the machine direction and stretching step (ii) stretches the non-porous laminate in the cross direction.

12. The process of claim 8, wherein the thermoplastic polymer of the polymeric filaments of the nonwoven substrate comprises polypropylene, polyester, nylon, or a mixture thereof.

13. The process of claim 12, wherein the thermoplastic polymer comprises polypropylene.

14. A microporous laminate comprising a first microporous polymeric surface coating on a nonwoven substrate, the nonwoven substrate having a first surface and an opposing second surface;
the first microporous polymeric surface coating comprising polypropylene copolymer, said polypropylene copolymer comprising polypropylene homopolymer chain segments and ethylene-containing copolymer chain segments in an amount of:
i) 50 to 95 weight percent polypropylene homopolymer chain segments, based on the weight of the polypropylene copolymer; or 43 to 79 mole percent polypropylene homopolymer chain segments, based on the mole content of polymerized units of polypropylene in the polypropylene homopolymer chain segments as a percentage of the total mole content of polymerized monomer units in the polypropylene copolymer; and
ii) 5 to 50 weight percent of ethylene-containing copolymer chain segments based on the weight of the polypropylene copolymer; or 21 to 57 mole percent of ethylene-containing copolymer chain segments based on the mole content of polymerized monomer units in the ethylene-containing copolymer chain segments as a percentage of the total mole content of polymerized monomer units in the polypropylene copolymer;
wherein at least a portion of the ethylene-containing copolymer chain segments comprise polymerized units of ethylene in an amount of at least 45 weight percent, based on the weight of the ethylene-containing copolymer chain segments; or at least 55 mole percent, based on the mole content of polymerized units of ethylene in the ethylene-containing copolymer chain segments as a percentage of the total mole content of polymerized monomer units in the ethylene-containing copolymer chain segments;
wherein the first microporous polymeric surface coating has a matrix phase of said polypropylene homopolymer chain segments, the matrix phase further having a plurality of domains of said ethylene-containing copolymer chain segments within said matrix phase,
the domains of the ethylene-containing copolymer chain segments further comprising an inclusion phase, within said domains, of said polypropylene homopolymer chain segments,
wherein the domains of said ethylene-containing copolymer chain segments within the matrix phase are fractured to form micropores in the first microporous polymeric surface coating, the first microporous polymeric surface coating having said fractured domains of ethylene-containing copolymer chain segments having an average thickness of 0.5 to 3.0 mils (12.7 to 76.2 micrometers), and
wherein the nonwoven substrate is a spunbonded nonwoven, a meltblown nonwoven, or some combination of spunbonded and meltblown nonwoven layers; the nonwoven substrate comprising a random network of filaments or fibers of thermoplastic polymer bonded together;
wherein the polypropylene copolymer of the first microporous polymeric surface coating is fused to filaments or fibers on the first surface of the nonwoven substrate; and
wherein the microporous laminate has a Gurley air permeability of 20 to 150 seconds/100 cm³ of air.

15. The microporous laminate of claim 14, wherein the thermoplastic polymer of the polymeric filaments or fibers of the nonwoven substrate comprises polypropylene, polyester, nylon, or a mixture thereof.

16. The microporous laminate of claim 15, wherein the thermoplastic polymer comprises polyester.

17. The microporous laminate of claim 14, further having:
(i) a basis weight of 30 g/m² to 100 g/m²,
(ii) a thickness of 3 to 15 mils (0.076 to 0.381 mm),
(iii) a hydrostatic head of 2.5 meters or greater,
(iv) a water vapor permeance of 200 g/(24 hr·m²) or greater, and
(v) a tensile strength of 10 lbs/inch (87.6 N/50 mm) or greater.

18. The microporous laminate of claim 14, further comprising a second microporous polymeric surface coating,
said second microporous polymeric surface coating being the same as the first microporous polymeric surface coating, and
wherein the polypropylene copolymer of the second microporous polymeric surface coating is fused to surface filaments or fibers on the opposing second surface of the nonwoven substrate;
wherein the microporous laminate has a Gurley air permeability of 20 to 150 seconds/100 cm³ of air.

19. The microporous laminate of claim 18, further having:
(i) a basis weight of 30 g/m² to 100 g/m²,
(ii) a thickness of 4 to 19 mils (0.10 to 0.48 mm),
(iii) a hydrostatic head of 3 meters or greater,
(iv) a water vapor permeance of 200 g/(24 hr·m²) or greater, and
(v) a tensile strength of 10 lbs/inch (87.6 N/50 mm) or greater.

20. A process for forming a microporous laminate, the microporous laminated comprising a first microporous polymeric surface coating on a first surface of a nonwoven substrate, the process comprising the steps of:
A) surface coating a molten layer of polymer on the first surface of the nonwoven substrate, followed by cooling, to form a non-porous laminate having a non-porous layer of said polymer on said first surface, the non-porous layer of polymer having an areal loading of 22.9 to 114.3 gsm and a thickness of 1-5 mils (25 to 125 micrometers), wherein:
a) the polymer is a composition comprising polypropylene copolymer, said polypropylene copolymer comprising polypropylene homopolymer chain segments and ethylene-containing copolymer chain segments in an amount of:
i) 50 to 95 weight percent polypropylene homopolymer chain segments, based on the weight of the polypropylene copolymer; or 43 to 79 mole percent polypropylene homopolymer chain segments, based on the mole content of polymerized units of polypropylene in the polypropylene homopolymer chain segments as a percentage of the total mole content of polymerized monomer units in the polypropylene copolymer; and
ii) 5 to 50 weight percent of ethylene-containing copolymer chain segments based on the weight of the polypropylene copolymer; or 21 to 57 mole percent of ethylene-containing copolymer chain segments based on the mole content of polymerized monomer units in the ethylene-containing copolymer chain segments as a percentage of the total mole content of polymerized monomer units in the polypropylene copolymer;
wherein at least a portion of the ethylene-containing copolymer chain segments comprise polymerized units of ethylene in an amount of at least 45 weight percent, based on the weight of the ethylene-containing copolymer chain segments; or at least 55 mole percent, based on the mole content of polymerized units of ethylene in the ethylene-containing copolymer chain segments as a percentage of the total mole content of polymerized monomer units in the ethylene-containing copolymer chain segments, and
wherein the non-porous layer of polymer has a matrix phase of said polypropylene homopolymer chain segments, the matrix phase further having a plurality of domains of said ethylene-containing copolymer chain segments within said matrix phase, the domains of the ethylene-containing copolymer chain segments further comprising an inclusion phase, within said domains, of said polypropylene homopolymer chain segments, and
b) the nonwoven substrate comprising a random network of filaments or fibers of thermoplastic polymer bonded together in the form of a spunbonded nonwoven, a meltblown nonwoven, or some combination of spunbonded and meltblown nonwoven layers; the nonwoven substrate having
(i) a basis weight of 30 to 100 gsm, and
(ii) an elongation at break at room temperature of 50 percent or greater;
B) subjecting the non-porous laminate to sequential cold and hot stretching steps comprising:
(i) at least one cold stretching step of 50 to 85 percent at a temperature of less than 30° C.; and
(ii) at least one hot stretching step of 100 to 150 percent at a temperature greater than 100° C.;
to fracture the domains of said ethylene-containing copolymer chain segments within the matrix phase to form micropores in the non-porous layer of polymer and produce the microporous laminate.

21. A process for forming a microporous laminate, the microporous laminated comprising a first microporous polymeric surface coating on a first surface of a nonwoven substrate, and a second microporous polymeric surface coating on an opposing second surface of a nonwoven substrate,
the process comprising the steps of:
A) surface coating a first molten layer of polymer on the first surface of the nonwoven substrate, followed by cooling, and surface coating a second molten layer of polymer on the opposing second surface of the nonwoven substrate, also followed by cooling, to form a non-porous laminate having a first non-porous layer of said polymer on said first surface and a second non-porous layer of said polymer on said second opposing surface, each non-porous layer of polymer having an areal loading of 22.9 to 114.3 gsm and a thickness of 1-5 mils (25 to 125 micrometers), wherein:
a) the polymer is a composition comprising polypropylene copolymer, said polypropylene copolymer comprising polypropylene homopolymer chain segments and ethylene-containing copolymer chain segments in an amount of:
i) 50 to 95 weight percent polypropylene homopolymer chain segments, based on the weight of the polypropylene copolymer; or 43 to 79 mole percent polypropylene homopolymer chain segments, based on the mole content of polymerized units of polypropylene in the polypropylene homopolymer chain segments as a percentage of the total mole content of polymerized monomer units in the polypropylene copolymer; and
ii) 5 to 50 weight percent of ethylene-containing copolymer chain segments based on the weight of the polypropylene copolymer; or 21 to 57 mole percent of ethylene-containing copolymer chain segments based on the mole content of polymerized monomer units in the ethylene-containing copolymer chain segments as a percentage of the total mole content of polymerized monomer units in the polypropylene copolymer;
wherein at least a portion of the ethylene-containing copolymer chain segments comprise polymerized units of ethylene in an amount of at least 45 weight percent, based on the weight of the ethylene-containing copolymer chain segments; or at least 55 mole percent, based on the mole content of polymerized units of ethylene in the ethylene-containing copolymer chain segments as a percentage of the total mole content of polymerized monomer units in the ethylene-containing copolymer chain segments, and
wherein each non-porous layer of polymer has a matrix phase of said polypropylene homopolymer chain segments, the matrix phase further having a plurality of domains of said ethylene-containing copolymer chain segments within said matrix phase, the domains of the ethylene-containing copolymer chain segments further comprising an inclusion phase, within said domains, of said polypropylene homopolymer chain segments, and
b) the nonwoven substrate comprising a spunbonded nonwoven having a random network of filaments or fibers of thermoplastic polymer bonded together at crossover points in the random network; the nonwoven substrate having
(i) a basis weight of 30 to 100 gsm, and
(ii) an elongation at break at room temperature of 50 percent or greater;
B) subjecting the non-porous laminate to sequential cold and hot stretching steps comprising:
(i) at least one cold stretching step of 50 to 85 percent at a temperature of less than 30° C.; and
(ii) at least one hot stretching step of 100 to 150 percent at a temperature greater than 100° C.;
to fracture the domains of said ethylene-containing copolymer chain segments within the matrix phase to form micropores in each non-porous layer of polymer and produce a microporous laminate.

22. The process of claim 20, wherein stretching steps (i) and (i) stretch the non-porous laminate solely in the machine direction.

23. The process of claim 20, wherein stretching step (i) stretches the non-porous laminate in the machine direction and stretching step (ii) stretches the non-porous laminate in the cross direction.

24. The process of claim 20, wherein the thermoplastic polymer of the polymeric filaments or fibers of the nonwoven substrate comprises polypropylene, polyester, nylon, or a mixture thereof.

25. The process of claim 24, wherein the thermoplastic polymer comprises polyester.

26. The process of claim 9, wherein stretching steps (i) and (i) stretch the non-porous laminate solely in the machine direction.

27. The process of claim 9, wherein stretching step (i) stretches the non-porous laminate in the machine direction and stretching step (ii) stretches the non-porous laminate in the cross direction.

28. The process of claim 9, wherein the thermoplastic polymer of the polymeric filaments of the nonwoven substrate comprises polypropylene, polyester, nylon, or a mixture thereof.

29. The process of claim 28, wherein the thermoplastic polymer comprises polypropylene.

30. The process of claim 21, wherein stretching steps (i) and (i) stretch the non-porous laminate solely in the machine direction.

31. The process of claim 21, wherein stretching step (i) stretches the non-porous laminate in the machine direction and stretching step (ii) stretches the non-porous laminate in the cross direction.

32. The process of claim 21, wherein the thermoplastic polymer of the polymeric filaments or fibers of the nonwoven substrate comprises polypropylene, polyester, nylon, or a mixture thereof.

33. The process of claim 32, wherein the thermoplastic polymer comprises polyester.
